(19) United States
(12) Patent Application Publication
(10) Pub. No.: US 2023/0320350 A1
(43) Pub. Date: Oct. 12, 2023

(54) Composite Pesticide Plugs and Related Methods

(71) Applicant: BOARD OF TRUSTEES OF MICHIGAN STATE UNIVERSITY, East Lansing, MI (US)

(72) Inventors: John C. Wise, Bath, MI (US); Christine Vandervoort, Williamston, MI (US); Annabel G. Wise, Bath, MI (US)

(21) Appl. No.: 18/022,589

(22) PCT Filed: Aug. 24, 2021
(86) PCT No.: PCT/US21/47232

§ 371 Date: Feb. 22, 2023

Related U.S. Application Data
(60) Provisional application No. 63/069,270, filed on Aug. 24, 2020.

(51) Int. Cl. A01N 25/34; A01N 25/10; A01N 43/90; A01N 59/26; A01N 37/18; A01P 7/04

(52) U.S. Cl. CPC A01N 25/34; A01N 25/10; A01P 7/04; A01N 59/26; A01N 37/18; A01N 43/90

(57) ABSTRACT

The disclosure relates to composite pesticide plugs for delivery of one or more plant protection materials to internal tree tissue of, for example, fruit trees. The composite pesticide plugs generally include a thermoplastic matrix including a low-temperature processable thermoplastic polymer such as polyvinyl acetate, a cellulosic reinforcement, and a plant protection material. The disclosure also relates to methods of preparing the composite pesticide plugs, and methods for delivering a plant protection material to trees. After injection into the tree trunk, the composite pesticide plug can provide a uniform, relatively consistent dose of plant protection material (e.g., pesticides, biopesticides, etc.) to all parts of the tree throughout the growing season, thus reducing waste of material and cost.

### CROSS REFERENCE TO RELATED APPLICATION

Priority is claimed to U.S. Provisional Application No. 63/069,270 filed on Aug. 24, 2020, which is incorporated herein by reference in its entirety.

### STATEMENT OF GOVERNMENT INTEREST

None.

### BACKGROUND OF THE DISCLOSURE

### Field of the Disclosure

The disclosure relates to pesticide plugs, in particular composite pesticide plugs for delivery of one or more plant protection materials to internal tree tissue. The disclosure also relates to methods of preparing the composite pesticide plugs and methods for delivering a plant protection material to a tree using the (composite) pesticide plugs. After injection into the tree trunk, the (composite) pesticide plug provides a uniform dose of pesticide throughout the growing season.

### Brief Description of Related Technology

Tree fruit producers currently rely on airblast ground sprayers to deliver pesticides to their orchards in order to control insects and disease pests. However, these airblast sprayers typically provide only 29% to 56% of the applied spray solution to the tree canopy, while the remaining solution drifts to the ground or other off-target end points. Pest management inputs comprise about 30% or more of the total annual variable costs in fruit production, and they significantly influence marketable yield. Trunk injection represents an alternate technology for the delivery of pesticides to tree fruit crops. Arborists have developed a variety of techniques for injecting pesticides directly into tree trunks, which then can be translocated from the injection site to the canopy area of insect feeding or disease infection. This technology has been successfully used in protecting ash trees from the Emerald ash borer (EAB) in urban and suburban landscapes because of minimal risks of applicator exposure, drift and impacts on non-target organisms, and superior duration of control compared to foliar application.

The commercial ARBORJET QUIK-JET system relies upon drilling a hole in the trunk, and injecting a pesticide solution into the cavity, after which the xylem translocates the material to the tree canopy. The ARBORSYSTEMS WEDGLE drills a shallow hole into the tree trunk, and then makes a pressure injection of liquid solution into the cambial zone of the trunk. These types of injection techniques result in a temporally variable residue profile in the tree canopy, resulting in unnecessarily high doses of insecticide. Another trunk injection technology, the ACECAP Systemic Insecticide Tree Implant, inserts a capsule containing the pesticide into the tree trunk. After the pesticide is released, however, the capsule remains as a contaminant that hinders tree healing. Both of these commercial systems can cause unacceptable injury to the tree trunk, thus hindering potential adoption in the tree fruit industry. The commercial BITE-INFUSION system avoids drilling large holes in the tree by slowly infusing the pesticide into the trunk with a needle-based system and pressure. This system can require an inordinate amount of time to inject a single tree, thus lower its potential for use in a tree fruit orchard system.

Accordingly, it would be desirable to provide a uniform dose of pesticide active ingredient to the tree throughout the growing season in a time- and labor-efficient manner which also enhances the healing of the tree after injection.

### SUMMARY

In one aspect, the disclosure relates to a composite pesticide plug for delivery of one or more plant protection materials to internal tree tissue, the composite pesticide plug comprising: (a) a thermoplastic polymer matrix comprising a thermoplastic polymer; (b) a cellulosic reinforcement or material distributed throughout the thermoplastic polymer matrix; and (c) a plant protection material (e.g., pesticide, biopesticide, etc.). In some embodiments, the thermoplastic polymer is adapted to form the thermoplastic polymer matrix and the composite plug at a temperature below a degradation temperature of the plant protection material. In some embodiments, the thermoplastic polymer comprises polyvinyl acetate (PVAc) or other non-water soluble thermoplastic polymer. In some embodiments, the thermoplastic polymer is in the form of a latex. In some embodiments, the thermoplastic polymer is adapted to form the thermoplastic polymer matrix and the composite plug at a temperature below 120° C., for example below 30, 50, 70, 90° C., where such temperature thresholds can be representative of degradation temperatures for some pesticides, in particular biopesticides. In some embodiments, the thermoplastic polymer is adapted to form the thermoplastic polymer matrix and the composite plug at a temperature in a range from 5° C. to 30° C., for example at a temperature of at least about 5, 10, 15, 20, 22, or 25 ° C. and/or up to about 22, 25, 27, or 30° C. More generally, the thermoplastic polymer is adapted to be combined with the cellulosic reinforcement and the plant protection material and then formed into a corresponding thermoplastic polymer matrix and composite plug without requiring melting or other high-temperature processing of the thermoplastic polymer. For example, a thermoplastic polymer initially in the form of an aqueous (or other liquid) dispersion of thermoplastic polymer microparticles is adapted to form a corresponding thermoplastic polymer in the form of a latex via drying/evaporation of the liquid medium and/or (partial) coalescence of the microparticles to form the latex matrix without elevated temperature processing.

In another aspect, the disclosure relates to a pesticide plug for delivery of one or more plant protection materials to internal tree tissue, the composite plug comprising: (a) a cellulosic material; and (b) a plant protection material, for example admixed with and/or bound to the cellulosic material (e.g., physically and/or chemically bound thereto). In some embodiments, the cellulosic material can be adapted to form the pesticide plug at a temperature below a degradation temperature of the plant protection material. In some embodiments, the cellulosic material is present in an amount ranging from about 60 wt % to about 99.9 wt %, based on the total weight of the pesticide plug, for example at least 60, 70, 80, or 90 wt % and/or up to 80, 90, 95, 98, 99, or 99.9 wt %. In some embodiments, the plant protection material is present in an amount ranging from about 0.1 wt % to about 40 wt %, based on the total weight of the pesticide plug, for example at least 0.1, 1, 2, 5, 10, 15, or 20 wt % and/or up to 5, 8, 12, 15, 20, 25, 30, 35, or 40 wt %.

Advantageously, the pesticide plugs and composite pesticide plugs of the present disclosure do not require high-temperature processing, such as melt blending, as compared to those described in, for example, Wise et al. U.S. Publication No. 2020/0128820, which describes PLA/PVOH-based plugs. Such high-temperature processing can degrade or otherwise inactivate or compromise the activity of heat-sensitive active ingredients, and prevent them from exerting their pest-control or other activity. A thermoplastic polymer that does not require high temperature to mold and form a solid matrix for its dispersed active ingredients, for example a polyvinyl acetate (PVAc)-based adhesive or glue (e.g., in a ˜50% solids aqueous dispersion), solves this problem because it can simply be blended with cellulose powder and active at room temperature (e.g., 10-30° C.) or other mildly elevated temperatures (e.g., up to about 50, 60, 70 or 80° C.) with some additional solvent or other liquid medium (e.g., ethanol) to provide a highly viscous blend that can be shaped as desired and then dried to form a plug. In general, there is no curing or other chemical reaction required to form the solid plug. Rather, just drying to remove any liquid suspending medium (e.g., water) for the PVAc and any additional solvent used to adjust consistency is generally sufficient.

Various refinements and embodiments of the disclosed pesticide plugs and composite pesticide plugs are possible.

The thermoplastic polymer can serve as a binder or a matrix for the cellulosic material and the plant protection material. In refinements, the thermoplastic polymer can include a non-water soluble thermoplastic polymer, such as polyvinyl acetate (PVAc), a water-soluble thermoplastic polymer, such as polyvinyl alcohol (PVOH), or a biodegradable thermoplastic polymer, such as polylactic acid (PLA).

In refinements, the thermoplastic polymer matrix comprises a non-water soluble thermoplastic polymer. The non-water soluble thermoplastic polymer is not particularly limited and can include, for example, non-water soluble vinyl polymers, polyesters, polyamides, polyarylene ethers, polyarylene sulfides, polyethersulf ones, polysulfones, polyether ketones, polyether ether ketones, polyurethanes, polycarbonates, polyamide-imides, polyimides, polyetherimides, polyacetals, silicones, mixtures thereof, etc. A vinyl polymer can produced, for example, by carrying out homopolymerization or copolymerization of vinyl monomers. The vinyl polymer can be a rubber-containing graft copolymer produced by graft copolymerization of vinyl monomers (such as styrene, other aromatic vinyl monomers, vinyl cyanide monomers, and other vinyl monomers) or their mixture under the existence of a rubbery polymer, or a vinyl polymer containing a rubbery polymer such as a composition of the former and a vinyl polymer. Specific example of non-water soluble thermoplastic polymers include polyethylene, polypropylene, polystyrene, poly(acrylonitrile-styrene-butadiene) resin (ABS), polytetrafluoroethylene (PTFE), polyacrylonitrile, polyacrylic amide, polyvinyl acetate, polybutyl acrylate, polymethyl methacrylate, and cyclic polyolefin. In refinements, the thermoplastic polymer comprises polyvinyl acetate.

In refinements, the thermoplastic polymer matrix further comprises a water-soluble thermoplastic polymer (e.g., PVOH). For example, some PVOH or other water-soluble thermoplastic polymers can be dissolved in a suitable solvent and combined with a PVAc-based formulation, and be used to make the composite pesticide plug by non-thermal processing means. The inclusion of a water-soluble polymer component, such as PVOH, in combination with a generally non-water soluble component such as PVAc can facilitate at least partial dissolution of the plug in the tree and release of the biopesticide.

The water-soluble thermoplastic polymer is not particularly limited and can include, for example, thermoplastic polymers (e.g., having a hydrocarbon or hydrocarbon-containing backbone) with one or more polar functional units such as hydroxyl groups, amino groups, carboxylic/carboxylate groups (e.g., acrylic/acrylate groups), and alkylene oxide repeat units. Examples of suitable water-soluble thermoplastic polymers include poly(vinyl alcohol) (PVOH), polyacrylates, polymethacrylates, water-soluble (meth)acrylate copolymers, polyvinyl pyrrolidones, polyethyleneimines, polyalkylene oxides, polyacrylic acids and salts thereof, and combinations thereof (e.g., polymer blends and/or copolymers of the respective monomers). PVOH is a particularly suitable water-soluble thermoplastic polymer. PVOH can include partially or completely hydrolyzed poly(vinyl acetate) with at least some vinyl alcohol repeat units and optionally some vinyl acetate repeat units, and it further can include copolymers with monomers of other than vinyl alcohol and vinyl acetate repeat units. In refinements, the thermoplastic polymer matrix comprises PVOH.

In refinements, the thermoplastic polymer comprises a biodegradable thermoplastic polymer. The biodegradable thermoplastic polymer is not particularly limited and can include, for example, biodegradable thermoplastic polyesters, polyamides, polyethers, copolymers thereof, mixtures thereof, etc. Examples of suitable biodegradable thermoplastic polymers include polyesters such as poly(lactic acid) (PLA), a poly(hydroxyalkanoate) (PHA), a poly(lactone), and combinations thereof (e.g., polymer blends and/or copolymers of the respective monomers). A poly(hydroxyalkanoate) can be a polymer polymerized from a HO—R¹—C(═O)OH monomer and/or including a —O—R¹—C(═O)— repeat unit, where R¹ is a linear or branched alkyl (or alkylene) group with 3 or more carbon atoms (e.g., at least 3 or 4 carbon atoms and/or up to 6, 8, or 10 carbon atoms). Examples of poly(hydroxyalkanoates) include poly-3-hydroxyvalerate (PHV), poly-4-hydroxybutyrate (P4HB), poly-3-hydroxybutyrate (P3HB), poly(3-hydroxybutyrate-co-3-hydroxyvalerate) (PHBV)). A poly(lactone) can be a polymer polymerized from a —O—R²—C(═O)— cyclic ester monomer and/or including a —O—R²—C(═O)— repeat unit, where R² is a linear alkyl (or alkylene) group with 1 or more carbon atoms (e.g., at least 2 or 4 carbon atoms and/or up to 5, 6, 8, or 10 carbon atoms). Examples of poly(lactones) include polyvalerolactone (PCL) and polycaprolactone (PCL)).

In refinements, the pesticide plug or composite pesticide plug is free from water-soluble thermoplastic polymers. For example, the composite pesticide plug can suitably contain less than about 5, 4, 3, 2, 1, 0.5, 0.1, 0.01, or 0.001 wt % of water-soluble thermoplastic polymers, such as PVOH, based on the total weight of the plug. Alternatively or additionally, in some refinements, the composite pesticide plug is free from biodegradable thermoplastic polymers. For example, the composite pesticide plug can suitably contain less than about 5, 4, 3, 2, 1, 0.5, 0.1, 0.01, or 0.001 wt % of biodegradable thermoplastic polymers, such as PLA, based on the total weight of the plug.

In refinements, the thermoplastic polymer matrix (e.g., PVAc) is present in an amount ranging from about 10 wt % to about 50 wt %, based on the total weight of the composite pesticide plug. For example, the composite pesticide plug can suitably contain at least about 10, 15, 20, 25, 30, or 35 wt % and/or up to 20, 25, 30, 35, 40, 45 or 50 wt % of the thermoplastic polymer matrix, based on the total weight of the composite pesticide plug. The thermoplastic polymer matrix amount can include all thermoplastic polymer species (e.g., PVAc and any water-soluble thermoplastic polymers, etc.) combined when there is more than one type in the plug. The foregoing amounts can be expressed on a wet- or dry-weight basis for the plug, for example before or after any water or other liquid solvent in the thermoplastic polymer medium has evaporated and the plug has solidified.

In refinements, the cellulosic reinforcement or material is selected from the group consisting of cellulose powder, wood flour, wood fibers, wood chips, wood flakes, and any combination thereof. The cellulosic (or wood) reinforcement material can be from any suitable source, for example a wood material or other lignocellulosic material. Suitable examples of the cellulosic material include powder, fiber, chip, flake, flour (e.g., sawdust or powder from a hardwood or softwood, for example, cedar, pine, maple, oak, ash, and/or spruce), etc. In some refinements, the cellulosic material is a cellulose powder. Examples of suitable, commercially available, cellulosic powders include, but are not limited to, SIGMACELL CELLULOSE Type 101-F, which is a highly purified, fibrous cellulose powder with an average particle size of about 50 μm.

In refinements, the cellulosic reinforcement or material can be a dried wood flour (e.g., having particle sizes between about 1 μm to about 1,000 μm, such as less than about 850 μm or a 20-mesh-pass size, less than about 500 μm or a 40-mesh-pass size, etc.), for example being dried in an oven for 24-48 hours at 105° C. to a moisture content of less than 1% before compounding and processing. Moisture can also be removed by venting during processing. The cellulosic material can be derived from virgin wood fibers or waste wood byproducts (e.g., urban or demolition wood waste, wood trim pieces, wood milling byproducts, pellets, paper pulp, sawdust, scrap paper/newspaper, etc.). Wood waste originated from plywood, particle board, medium density fiberboard, and CCA-treated timber (i.e., chromated copper arsenate) can also be used.

The cellulosic reinforcement or material can be derived from other lignocellulosic materials, for example, leaves and fruit peels (e.g., orange or other citrus fruit peels, apple pees, etc.). Other suitable cellulosic materials include natural fibers from lignocellulosic materials, such as flax, bagass, jute, hemp, sisal, cotton, ramie, coir, straw, and the like. The cellulosic materials can vary in size, shape, particle size distribution, and aspect ratio (e.g., chips, flake, flours, fibers, etc.). For example, cellulosic materials can have a microscale size, for example having particle sizes ranging from about 1 μm to about 1000 μm (e.g., at least about 1 μm or 10 μm and/or up to about 500 μm, 850 μm, or 1000 μm). In other refinements, cellulosic materials can have a nanoscale size, for example having particle sizes ranging from about 1 nm to about 1000 nm (e.g., at least about 1 nm, 5 nm, 10 nm, or 20 nm and/or up to about 50 nm, 100 nm, 200 nm, 500 nm, or 1000 nm). Examples of suitable nanoscale cellulosic materials include cellulosic nanomaterials, which can be extracted from lignocellulosic materials by known mechanical and/or chemical methods. Cellulosic nanocrystals can have an approximate spherical shape or irregular shape with a low aspect ratio, and cellulosic nanofibers can be a high aspect ratio with a nanoscale diameter and a microscale length. A suitable cellulosic material includes a softwood pine wood flour. Pine wood flour and other relatively porous wood flour are particularly suitable for polymer blending.

In refinements, the cellulosic reinforcement or material comprises cellulose powder.

In refinements, the cellulosic reinforcement or material comprises one or more cellulose derivatives, for example in powder form, fiber form, etc. For example, the cellulosic reinforcement or material can comprise a cellulose derivative selected from the group consisting of carboxymethyl cellulose (CMC) carboxymethyl hydroxyethylcellulose, hydroxyethyl cellulose (HEC), hydroxypropyl cellulose (HPC), hydroxypropyl methylcellulose (HPMC), hydroxyethyl methylcellulose (HPMC), ethyl hydroxyethylcellulose, methyl ethyl hydroxyethylcellulose, methyl cellulose (MC), ethyl cellulose (EC), ethyl methyl cellulose (EMC), diethylaminoethyl cellulose (DEAE-C), a salt thereof, and a combination thereof.

In refinements, the cellulose derivative is carboxymethyl cellulose.

In refinements, the carboxymethyl cellulose is sodium carboxymethyl cellulose.

In refinements, the cellulosic reinforcement or material is present in an amount ranging from about 30 wt % to about 60 wt %, based on the total weight of the composite pesticide plug. For example, the composite pesticide plugs can include at least about 30, 35, 40, 45, or 50 wt % and/or up to about 40, 45, 50, 55, or 60 wt % of the cellulosic reinforcement, based on the total weight of the composite pesticide plug.

In refinements, the ratio of polyvinyl acetate to cellulosic reinforcement in the composite pesticide plug is in a range of about 1:4 to about 1:1. For example, the ratio of PVAc to cellulosic reinforcement (e.g., wood flour, cellulose powder, etc.) can be at least about 1:4, 1:3.5, 1:3, 1:2.5, or 1:2 and/or up to about 1:3, 1:2.5, 1:2, 1:1.5, or 1:1. In refinements, the ratio of PVAc to cellulosic reinforcement is about 1:3 to about 2:3.

In refinements, the plant protection material is homogeneously distributed throughout the thermoplastic polymer matrix. For example, the plant protection material (e.g., biopesticide, pesticide, etc.) can be present as a miscible blend with the polymeric components of the plug matrix. Most common technical grade pesticides are naturally dry (or solid) materials at ambient room/environmental temperatures, and they can be combined directly in dry form with the other plug components, or they formulated as liquids (e.g., with a suitable solvent) for combination with the other plug components.

In refinements, the plant protection material is selected from the group consisting of pesticides, biopesticides, plant growth regulators, fertilizers, and combinations (e.g., mixtures) thereof.

In refinements, the plant protection material comprises a biopesticide. In refinements, the biopesticide is selected from the group consisting of azadirachtin, peptides, fermentation by-products, fungal agents (e.g., Beauvaria), and combinations thereof. Biopesticides are generally known in the art and can target one or more types of tree pests as do conventional chemical pesticides, but they are derived from natural materials such as animals, plants, bacteria, fungi, and certain minerals. Biopesticides are preferably selected that are xylem-mobile, which facilitates their transport from the plug to the tree canopy or other surface tree tissue, and/or ingestion-active, which allows the biopesticide to act upon a target pest after ingestion by the pest. For example, the target pest can ingest biopesticide by consuming leaves or other plant tissue to which the biopesticide has been transported by xylem transport. Internal tree plug delivery and xylem transport of the biopesticide helps preserve the activity of the biopesticide, which typically is very sensitive to UV degradation. When the biopesticide is internally delivered and transported throughout the tree, it remains largely shielded from degrading UV radiation before it is consumed by the pest. In contrast, a biopesticide that is applied foliarly to the canopy or other exterior environmental surface of the tree can be subject to rapid UV degradation, or degradation due to soil microbes, prior to ingestion by the pest(s).

In refinements, the plant protection material comprises a pesticide. In refinements, the pesticide is selected from the group consisting of neonicotinoids, avermectins, diamides, sterol inhibitors, oxytetracycline, phosphorous acid, derivatives thereof, and combinations thereof. The pesticide is not particularly limited and can include any pesticides (e.g., insecticides, fungicides, miticides and/or antibiotics used for tree health) that target one or more tree pests and that are compatible with xylem (and optionally phloem) transport with a target tree. Xylem tissue within the tree trunk, branches (e.g., scaffold branches, lateral branches), stems, leaves, etc. provides a transport path for water from the roots, through the trunk, branches, stems, etc., and to the leaves. Naturally transported water through the xylem tissue provides a vehicle for transport and delivery of the pesticide in combination with the water-soluble thermoplastic polymer from the plug. Similarly, phloem tissue within the tree provides transport for water-soluble sugars and can assist in pesticide delivery as well. Suitable classes of pesticides include neonicotinoids, avermectins, diamides (e.g., diamide insecticides), sterol inhibitors (e.g., sterol inhibitor fungicides), oxytetracycline (e.g., a tetracycline group antibiotic), phosphorous acid, derivatives thereof, and combinations or mixtures thereof. Example derivative forms include salts such as metal salts (e.g., alkali and/or alkali earth metal salt) and amine salts (e.g., as mono-, di-, or tri-alkyl or alkanol amine; amine salt with a halogen such as chloride or a carboxylate such as benzoate), esters (e.g., alkyl esters), and amides. Example neonicotinoids include acetamiprid, clothianidin, imidacloprid, nitenpyram, nithiazine, thiacloprid, and thiamethoxam. Example avermectins include ivermectin, selamectin, doramectin, abamectin, and emamectin (a 4″-deoxy-4″-methylamino derivative of abamectin, such as in the form of a benzoic acid amine salt). Example diamides include broflanilide, cyantraniliprole, flubendiamide, and chlorantraniliprole. Example sterol inhibitors include triazole fungicides (e.g., tebuconazole, propiconazole), imidazoles (e.g., imazalil), and pyrimidines (e.g., fenarimol).

Examples of any of the various plant protection materials known in the art for promoting tree health, such as materials which kill or inactivate tree pests, increase a tree's resistance to pests, and/or promote tree growth, etc. can be used. Plant protection materials can include pesticides (e.g., as described above), biopesticides (e.g., as described above), plant growth regulators, and fertilizers, for example. The composite pesticide plugs can include multiple different types of plant protection materials, for example two or more plant protection materials of the same or different type (e.g., two different types of pesticide, one pesticide and one fertilizer, etc.). Plant growth regulators are generally known in the art and can include various synthetic or natural substances that stimulate or otherwise regulate plant growth in a manner or mechanism similar to that of natural plant hormones. Fertilizers, whether specifically tailored for trees specifically or plants more generally, are generally known in the art and can include one or more plant nutrients such as macronutrients (e.g., nitrogen, phosphorus, potassium, calcium, sulfur, and/or magnesium) or micronutrients (e.g., trace minerals such as boron, chlorine, manganese, iron, zinc, copper, molybdenum, nickel, and/or cobalt) desired to supplement the nutrients from the tree's local soil environment. As used herein, description related to pesticides is understood to apply more generally to any active ingredient or plant protection material for inclusion in the composite plug (e.g., present in the thermoplastic polymer matrix such as being homogeneously distributed throughout the matrix).

In refinements, the plant protection material (e.g., biopesticide, pesticide, etc.) is present in the composite pesticide plug in an amount ranging from about 10 wt % to about 30 wt %, based on the total weight of the composite pesticide plug. For example, the plant protection material can be present in an amount of about 10, 12, 15, 17, 20, 22 or 25 wt % and/or up to about 15, 17, 20, 22, 25, 27, or 30 wt %, based on the total weight of the composite pesticide plug. The foregoing amounts can be expressed on a wet- or dry-weight basis for the plug, for example before or after any water or other liquid solvent in the thermoplastic polymer medium has evaporated and the plug has solidified.

In refinements, the pesticide plug or composite pesticide plug has an elongate geometry.

In another aspect, the disclosure relates to a method for delivering a plant protection material to a tree, the method comprising inserting the composite pesticide plug of the disclosure into an interior trunk region of a live tree.

Various refinements of the disclosed method for delivering a plant protection material to a tree are possible.

In refinements, the method comprises inserting the pesticide plug or composite pesticide plug at height ranging from about 0.1 m to about 1 m above ground, for example at least about 0.1, 0.2, 0.25, 0.3, 0.4, 0.5, 0.6, or 0.7 m and/or up to 0.4, 0.5, 0.6, 0.7, 0.75, 0.8, 0.9, or 1.0 m above ground.

In refinements, the method comprises inserting a plurality of the pesticide plugs or composite pesticide plugs distributed circumferentially around the tree trunk. For example, at least 2, 3, 4, 5, 6, or 7 and/or up to 5, 6, 7, 8, 9, or 10 composite pesticide plugs can be inserted into the tree trunk. The plurality of pesticide plugs can be distributed evenly around the circumference of the tree trunk, such that the distance between each of the plurality of plugs is the same. Alternatively, or additionally, the plugs can be arranged in clusters of plugs (e.g., at least 2, 3, or 4 and/or up 3, 4, or 5 plugs), and the clusters of plugs can be distributed evenly around the circumference of the tree trunk, such that the distance between each of the clusters is the same. The plurality of plugs (or clusters thereof) can be arranged at the same height (e.g., above ground), or at various heights.

In refinements, the tree is a fruit tree selected from the group consisting of apple trees, cherry trees, grapefruit trees, lemon trees, nectarine trees, orange trees, peach trees, pear trees, plum trees, and pomegranate trees.

In another aspect, the disclosure relates to a method of preparing the composite pesticide plug as described herein, the method comprising: admixing the thermoplastic polymer, the cellulosic reinforcement, and the plant protection material to provide the composite pesticide plug, wherein the admixing is performed at a temperature of about 5° C. to about 30° C., of about 10° C. to about 30° C., or about 15° C. to about 30° C. For example, the admixing can be performed at a temperature of at least about 5, 10, 15, 20, 22, or 25° C. and/or up to about 22, 25, 27, or 30° C. In refinements, the method is free of a heat extrusion process (e.g., melt blending). More generally, the method does not involve thermal or melt processing, whether by extrusion, molding, etc. Suitably, from the initial admixing of the separate components to the final (dried/solid) plug, the components are not exposed to temperatures above about 30, 50, 70, 90, or 120° C.

In refinements, the admixing further comprises adding at least one liquid (e.g., water, organic solvent, etc.) to the thermoplastic polymer, the cellulosic reinforcement, and the plant protection material, thereby forming a moldable mixture comprising the liquid, the thermoplastic polymer, the cellulosic reinforcement, and the plant protection material; and the method further comprises drying the moldable mixture to remove at least some (e.g., substantially all) of the liquid, thereby forming the composite pesticide plug.

In another aspect, the disclosure relates to a method of preparing the pesticide plug as described herein, the method comprising: admixing the cellulosic material and the plant protection material to provide the pesticide plug, wherein the admixing is performed at a temperature of about 5° C. to about 30° C., of about 10° C. to about 30° C., or about 15° C. to about 30° C. For example, the admixing can be performed at a temperature of at least about 5, 10, 15, 20, 22, or 25° C. and/or up to about 22, 25, 27, or 30° C. In refinements, the method is free of a heat extrusion process (e.g., melt blending). More generally, the method does not involve thermal or melt processing, whether by extrusion, molding, etc. Suitably, from the initial admixing of the separate components to the final (dried/solid) plug, the components are not exposed to temperatures above about 30, 50, 70, 90, or 120° C.

In refinements, the admixing further comprises adding at least one liquid (e.g., water, organic solvent) to the cellulosic material and the plant protection material, thereby forming a moldable mixture comprising the liquid, the cellulosic material, and the plant protection material; and the method further comprises drying the moldable mixture to remove at least some (e.g., substantially all) of the liquid, thereby forming the pesticide plug.

While the disclosed composite pesticide plugs and methods are susceptible of embodiments in various forms, specific embodiments of the disclosure are illustrated (and will hereafter be described) with the understanding that the disclosure is intended to be illustrative, and is not intended to limit the claims to the specific embodiments descried and illustrated herein.

### BRIEF DESCRIPTION OF THE DRAWINGS

For a more complete understanding of the disclosure, reference should be made to the following detailed description and accompanying drawings wherein:

FIG. 1A illustrates the amount of pesticide (i.e., dsRNA) per 25 mg leaf tissue from leaf samples taken from the apple tree canopies over five sampling dates, following injection with dsRNA liquid injection and cellulose-PVA plug vs. untreated control.

FIG. 1B illustrates the amount of pesticide (i.e., dsRNA) per 25 mg leaf tissue from leaf samples taken from the apple tree canopies over five sampling dates, following injection with dsRNA liquid injection and cellulose-PVA plug (excluding untreated control).

FIG. 2 illustrates the mortality (+SD) of adult female mites (Tetranychus urticae) exposed for five days to leaf discs cut from apple trees treate with dsRNA.

FIG. 3 illustrates the mean (+SD) percentage survival of mites exposed to leaf discs cut from apple trees with dsRNA.

FIG. 4 illustrates results from plugs containing imidacloprid (imi PVOH-wood and imi PLA-cellulose) vs. liquid.

FIG. 5 illustrates the detection of imidacloprid residues (ppbs) in apple leaves following treatments with imidacloprid-cellulosic material plugs according to the disclosure.

FIG. 6 illustrates temporal profile of mean azadirachtin residues (ppms) in pear leaves following treatments.

FIG. 7 illustrates azadirachtin plug control of obliquebanded leafroller (OBLR) larvae in potted apple trees.

### DETAILED DESCRIPTION

The disclosure relates to a slow-release biodegradable pesticide plug or composite pesticide plug that can be used for trunk injection delivery of a plant protection material (e.g., pesticide or biopesticide) to protect woody plants (e.g., trees and fruit trees in particular) against pests. The composite pesticide plug generally includes a thermoplastic polymer matrix including a thermoplastic polymer, a cellulosic reinforcement or material distributed throughout the thermoplastic polymer matrix, and a plant protection material (e.g., pesticide, biopesticide), wherein the thermoplastic polymer is adapted to form the thermoplastic polymer matrix and the composite plug at a temperature below a degradation temperature of the plant protection material. The pesticide plug generally includes cellulosic reinforcement or material and a plant protection material bound to the cellulosic material, and is typically free from thermoplastic polymers or other polymer materials/binders. In embodiments without the thermoplastic polymer, the plug may be alternatively referenced as a “pesticide plug” instead of a “composite pesticide plug.” General references herein to “composite pesticide plug” can correspond to either embodiment (i.e., with or without the thermoplastic polymer). After injection into the tree trunk, the composite pesticide plug provides a uniform, relatively consistent dose of active ingredient (e.g., plant protection materials, pesticide, dsRNA, or otherwise) to all parts of the tree throughout the growing season, thus reducing waste of material and cost. The biodegradable nature of the composite pesticide plug also enhances the healing of the tree after injection.

### Composite Pesticide Plug

A pesticide plug or composite pesticide plug according to the disclosure includes a cellulosic reinforcement or material, one or more plant protection materials such as a pesticide or biopesticide (e.g., bound to the cellulosic reinforcement or material), and optionally, a thermoplastic polymer matrix. Typically, the plugs of the disclosure are composite pesticide plugs containing a thermoplastic polymer matrix including a thermoplastic polymer, as described herein.

The pesticide plugs and composite pesticide plugs of the present disclosure advantageously do not require high-temperature processing, such as melt blending, as compared to those described in, for example, Wise et al. U.S. Publication No. 2020/0128820, which describes PLA/PVOH-based plugs. Such high-temperature processing can degrade or otherwise inactivate or compromise the activity of heat-sensitive active ingredients, and prevent them from exerting their pest-control or other activity. A thermoplastic polymer that does not require high temperature to mold and form a solid matrix for its dispersed active ingredients, for example a polyvinyl acetate (PVAc)-based adhesive or glue (e.g., in a −50% solids aqueous dispersion), solves this problem because it can simply be blended with cellulose powder and active at room temperature (e.g., 10-30° C.) or other mildly elevated temperatures (e.g., up to about 50, 60, 70 or 80° C.) with some additional solvent or other liquid medium (e.g., ethanol) to provide a highly viscous blend that can be shaped as desired and then dried to form a plug. In general, there is no curing or other chemical reaction required to form the solid plug. Rather, just drying to remove any liquid suspending medium (e.g., water) for the PVAc and any additional solvent used to adjust consistency is generally sufficient.

In some embodiments, the disclosed plugs do not include a thermoplastic polymer matrix. In embodiments that do not include a thermoplastic polymer, the cellulosic reinforcement or material can be adapted to form the pesticide plug, for example with the cellulosic material as a matrix or otherwise a substantial majority of the plug body. In embodiments with or without a thermoplastic polymer, the plant protection material can be bound to the cellulosic material. The plant protection material can be bound to the cellulosic material via chemical mechanisms and/or physical mechanisms. For example, the plant protection material can be chemically bonded to the cellulosic material via covalent bonds, hydrophobic interactions, hydrogen bonds, ionic bonds, polar and dipole-dipole interactions, and the like. Alternatively or additionally, the plant protection material can be physically bonded to the cellulosic material, such as by being adsorbed to the surface of the cellulosic material as a result of admixing.

The pesticide plug or composite pesticide plug can have any desired shape, but it is suitably shaped based on ease of processing and a desire to have a relatively large relative surface area (e.g., surface area/volume or surface area/mass ratio). In some embodiments, the plug has an elongate geometry, which can be suitably formed by extrusion or compression molding as described below and illustrated in the examples. For example, the plug can have a generally cylindrical geometry (e.g., to maximize relative surface area for an elongate or axially symmetric shape), such as having a length (L) of at least 1, 2, 5, 10, 15, or 25 mm and/or up to 10, 20, 30, 50, or 100 mm, and/or having a diameter (D) (or width/equivalent diameter for non-cylinders) of at least 1, 2, 5, or 10 mm and/or up to 5, 8, 10, 15, or 25 mm. The L/D aspect ratio can be at least 1:1 or 2:1 and/or up to 3:1, 4:1, 6:1, or 8:1. The specific geometry/size can be selected to have a desired total volume in terms of amount of active (pesticide) ingredient to be delivered and to have a desired specific surface area (area per unit volume) to control delivery rate. The plug in any form is preferably free from a coating or encapsulating material.

In refinements containing a thermoplastic polymer, the ratio of the thermoplastic polymer (e.g., PVAc or otherwise) to the cellulose material (e.g., wood flour, cellulose powder, cellulose derivative, or otherwise) can be about 1:4 to about 1:1, for example at least about 1:4, 1:3.5, 1:3, 1:2.5, or 1:2 and/or up to about 1:3, 1:2.5, 1:2, 1:1.5, 1:1:1. For example, the thermoplastic polymer matrix can be present in an amount ranging from about 10 wt % to about 50 wt %, based on the total weight of the composite pesticide plug; and the cellulosic material can be present in an amount ranging from about 30 wt % to about 60 wt % or about 50 wt % to about 90 wt %, based on the total weight of the composite pesticide plug. For example, the thermoplastic polymer matrix can be present in an amount of at least about 10, 15, 20, 25, 30, or 35 wt % and/or up to about 25, 30, 35, 40, 45 or 50 wt %, based on the total weight of the composite pesticide plug, and the cellulosic material can be present in an amount ranging from about 30, 35, 40, 45, 50, 55, or 60 wt % and/or up to about 40, 45, 50, 55, 60, 65, 70, 75, 80, 85 or 90 wt %, based on the total weight of the composite pesticide plug.

In refinements without the thermoplastic polymer matrix, the amount of the cellulosic material in the pesticide plug can range from 60 wt % to 99.9 wt % relative to the pesticide plug as a whole. For example, the pesticide plug can contain at least 60, 70, 80, or 90 wt % and/or up to 80, 90, 95, 98, 99, or 99.9 wt % cellulosic materials, such as where the balance can include the plant protection material and any optional non-cellulosic components.

### Thermoplastic Polymer Matrix

In some embodiments, the disclosure provides composite pesticide plugs containing a thermoplastic polymer matrix, as described herein. For example, the plug can include a thermoplastic polymer such as polyvinyl acetate (PVAc), etc., which can also serve as a binder or a matrix for the cellulosic material and the plant protection material. In refinements, the thermoplastic polymer can include a non-water soluble thermoplastic polymer, such as polyvinyl acetate (PVAc), a water-soluble thermoplastic polymer, such as polyvinyl alcohol (PVOH), or a biodegradable thermoplastic polymer, such as polylactic acid (PLA). The thermoplastic polymer component is not required, however, to form a plug that maintains its shape as a solid. For example, a plug formed from a slurry or other mixture of cellulosic material, plant protection material, and salts/other buffers that is placed into a mold (e.g., a syringe body/barrel) and allowed to dry can form a solid plug.

The thermoplastic polymer matrix generally forms a continuous phase for the composite pesticide plug. When two or more thermoplastic polymers are used for the thermoplastic polymer matrix (e.g., the non-water-soluble thermoplastic polymer and any additional thermoplastic polymer(s)), they generally form a miscible blend as a continuous, homogeneous polymeric phase. The cellulosic reinforcement or material, for example with or without the plant protection material bound thereto, is distributed throughout the thermoplastic polymer matrix, for example as discrete, heterogeneous particles essentially evenly distributed throughout the continuous phase. The inclusion of the cellulosic material in a substantial amount in the plug enhances biodegradability of the plug and eventual healing of the tree after injection. In some embodiments, the plant protection materials also can be present in the thermoplastic polymer matrix, for example being homogeneously distributed throughout the thermoplastic polymer matrix.

The thermoplastic polymer is adapted to form the thermoplastic polymer matrix and the composite plug at a temperature below a degradation temperature of the plant protection material. In some embodiments, the thermoplastic polymer includes polyvinyl acetate (PVAc) or other non-water soluble thermoplastic polymer. In some embodiments, the thermoplastic polymer is in the form of a latex. In some embodiments, the thermoplastic polymer is adapted to form the thermoplastic polymer matrix and the composite plug at a temperature below 120° C., for example below 30, 50, 70, 90° C., where such temperature thresholds can be representative of degradation temperatures for some pesticides, in particular biopesticides. In some embodiments, the thermoplastic polymer is adapted to form the thermoplastic polymer matrix and the composite plug at a temperature in a range from 5° C. to 30° C., for example at a temperature of at least about 5, 10, 15, 20, 22, or 25° C. and/or up to about 22, 25, 27, or 30° C. More generally, the thermoplastic polymer is adapted to be combined with the cellulosic reinforcement and the plant protection material and then formed into a corresponding thermoplastic polymer matrix and composite plug without requiring melting or other high-temperature processing of the thermoplastic polymer. For example, a thermoplastic polymer initially in the form of an aqueous (or other liquid) dispersion of thermoplastic polymer microparticles is adapted to form a corresponding thermoplastic polymer in the form of a latex via drying/evaporation of the liquid medium and/or (partial) coalescence of the microparticles to form the latex matrix without elevated temperature processing.

In refinements, the thermoplastic polymer matrix includes a non-water soluble thermoplastic polymer. The non-water soluble thermoplastic polymer is not particularly limited and can include, for example, non-water soluble vinyl polymers, polyesters, polyamides, polyarylene ethers, polyarylene sulfides, polyethersulfones, polysulfones, polyether ketones, polyether ether ketones, polyurethanes, polycarbonates, polyamide-imides, polyimides, polyetherimides, polyacetals, silicones, mixtures thereof, etc. A vinyl polymer can produced, for example, by carrying out homopolymerization or copolymerization of vinyl monomers. The vinyl polymer can be a rubber-containing graft copolymer produced by graft copolymerization of vinyl monomers (such as styrene, other aromatic vinyl monomers, vinyl cyanide monomers, and other vinyl monomers) or their mixture under the existence of a rubbery polymer, or a vinyl polymer containing a rubbery polymer such as a composition of the former and a vinyl polymer. Specific example of non-water soluble thermoplastic polymers include polyethylene, polypropylene, polystyrene, poly(acrylonitrile-styrene-butadiene) resin (ABS), polytetrafluoroethylene (PTFE), polyacrylonitrile, polyacrylic amide, polyvinyl acetate, polybutyl acrylate, polymethyl methacrylate, and cyclic polyolefin. In refinements, the thermoplastic polymer includes polyvinyl acetate.

In refinements, the thermoplastic polymer matrix further includes a water-soluble thermoplastic polymer (e.g., PVOH). For example, some PVOH or other water-soluble thermoplastic polymers can be dissolved in a suitable solvent and combined with a PVAc-based formulation, and be used to make the composite pesticide plug by non-thermal processing means. The inclusion of a water-soluble polymer component, such as PVOH, in combination with a generally non-water soluble component such as PVAc can facilitate at least partial dissolution of the plug in the tree and release of the biopesticide.

The water-soluble thermoplastic polymer is not particularly limited and can include, for example, thermoplastic polymers (e.g., having a hydrocarbon or hydrocarbon-containing backbone) with one or more polar functional units such as hydroxyl groups, amino groups, carboxylic/carboxylate groups (e.g., acrylic/acrylate groups), and alkylene oxide repeat units. Examples of suitable water-soluble thermoplastic polymers include poly(vinyl alcohol) (PVOH), polyacrylates, polymethacrylates, water-soluble (meth)acrylate copolymers, polyvinyl pyrrolidones, polyethyleneimines, polyalkylene oxides, polyacrylic acids and salts thereof, and combinations thereof (e.g., polymer blends and/or copolymers of the respective monomers). PVOH is a particularly suitable water-soluble thermoplastic polymer. PVOH can include partially or completely hydrolyzed poly(vinyl acetate) with at least some vinyl alcohol repeat units and optionally some vinyl acetate repeat units, and it further can include copolymers with monomers of other than vinyl alcohol and vinyl acetate repeat units. In refinements, the thermoplastic polymer matrix includes PVOH.

In refinements, the thermoplastic polymer includes a biodegradable thermoplastic polymer. The biodegradable thermoplastic polymer is not particularly limited and can include, for example, biodegradable thermoplastic polyesters, polyamides, polyethers, copolymers thereof, mixtures thereof, etc. Examples of suitable biodegradable thermoplastic polymers include polyesters such as poly(lactic acid) (PLA), a poly(hydroxyalkanoate) (PHA), a poly(lactone), and combinations thereof (e.g., polymer blends and/or copolymers of the respective monomers). A poly(hydroxyalkanoate) can be a polymer polymerized from a HO—R¹—C(═O)OH monomer and/or including a —O—R¹—C(═O)— repeat unit, where R¹ is a linear or branched alkyl (or alkylene) group with 3 or more carbon atoms (e.g., at least 3 or 4 carbon atoms and/or up to 6, 8, or 10 carbon atoms). Examples of poly(hydroxyalkanoates) include poly-3-hydroxyvalerate (PHV), poly-4-hydroxybutyrate (P4HB), poly-3-hydroxybutyrate (P3HB), poly(3-hydroxybutyrate-co-3-hydroxyvalerate) (PHBV)). A poly(lactone) can be a polymer polymerized from a —O—R²—C(═O)— cyclic ester monomer and/or including a —O—R²—C(═O)— repeat unit, where R² is a linear alkyl (or alkylene) group with 1 or more carbon atoms (e.g., at least 2 or 4 carbon atoms and/or up to 5, 6, 8, or 10 carbon atoms). Examples of poly(lactones) include polyvalerolactone (PCL) and polycaprolactone (PCL)).

In refinements, the pesticide plug or composite pesticide plug is free from water-soluble thermoplastic polymers. For example, the composite pesticide plug can suitably contain less than about 5, 4, 3, 2, 1, 0.5, 0.1, 0.01, or 0.001 wt % of water-soluble thermoplastic polymers, such as PVOH, based on the total weight of the plug. Alternatively or additionally, in some refinements, the composite pesticide plug is free from biodegradable thermoplastic polymers. For example, the composite pesticide plug can suitably contain less than about 5, 4, 3, 2, 1, 0.5, 0.1, 0.01, or 0.001 wt % of biodegradable thermoplastic polymers, such as PLA, based on the total weight of the plug.

In refinements, the thermoplastic polymer matrix (e.g., PVAc) is present in an amount ranging from about 10 wt % to about 50 wt %, based on the total weight of the composite pesticide plug. For example, the composite pesticide plug can suitably contain at least about 10, 15, 20, 25, 30, or 35 wt % and/or up to 20, 25, 30, 35, 40, 45 or 50 wt % of the thermoplastic polymer matrix, based on the total weight of the composite pesticide plug. The thermoplastic polymer matrix amount can include all thermoplastic polymer species (e.g., PVAc and any water-soluble thermoplastic polymers, etc.) combined when there is more than one type in the plug. The foregoing amounts can be expressed on a wet- or dry-weight basis for the plug, for example before or after any water or other liquid solvent in the thermoplastic polymer medium has evaporated and the plug has solidified.

### Cellulosic Reinforcement

The pesticide plugs of the disclosure contain a cellulosic reinforcement or material. As used herein, the terms “cellulosic reinforcement” and “cellulosic material” are used interchangeably. In some embodiments, the cellulosic reinforcement contains a cellulose derivative, as described herein. In an aspect, the cellulosic material functions as a substrate to which the plant protection material is bound. In another aspect, the cellulosic material functions to facilitate healing of the tree after injection of the disclosed plugs.

The cellulosic reinforcement or material may be from any suitable source, for example a wood material or other lignocellulosic material, including chemically modified derivatives thereof. In refinements, the cellulosic reinforcement or material is selected from the group consisting of cellulose powder, wood flour, wood fibers, wood chips, wood flakes, and any combination thereof. The cellulosic (or wood) reinforcement material can be from any suitable source, for example a wood material or other lignocellulosic material. Suitable examples of the cellulosic material include powder, fiber, chip, flake, flour (e.g., sawdust or powder from a hardwood or softwood, for example, cedar, pine, maple, oak, ash, and/or spruce), etc. In some refinements, the cellulosic material is a cellulose powder. Examples of suitable, commercially available, cellulosic powders include, but are not limited to, SIGMACELL CELLULOSE Type 101-F, which is a highly purified, fibrous cellulose powder with an average particle size of about 50 μm.

In refinements, the cellulosic reinforcement or material can be a dried wood flour (e.g., having particle sizes between about 1 μm to about 1,000 μm, such as less than about 850 μm or a 20-mesh-pass size, less than about 500 μm or a 40-mesh-pass size, etc.), for example being dried in an oven for 24-48 hours at 105° C. to a moisture content of less than 1% before compounding and processing. Moisture can also be removed by venting during processing. The cellulosic material can be derived from virgin wood fibers or waste wood byproducts (e.g., urban or demolition wood waste, wood trim pieces, wood milling byproducts, pellets, paper pulp, sawdust, scrap paper/newspaper, etc.). Wood waste originated from plywood, particle board, medium density fiberboard, and CCA-treated timber (i.e., chromated copper arsenate) can also be used.

The cellulosic reinforcement or material can be derived from other lignocellulosic materials, for example, leaves and fruit peels (e.g., orange or other citrus fruit peels, apple pees, etc.). Other suitable cellulosic materials include natural fibers from lignocellulosic materials, such as flax, bagass, jute, hemp, sisal, cotton, ramie, coir, straw, and the like. The cellulosic materials can vary in size, shape, particle size distribution, and aspect ratio (e.g., chips, flake, flours, fibers, etc.). For example, cellulosic materials can have a microscale size, for example having particle sizes ranging from about 1 μm to about 1000 μm (e.g., at least about 1 μm or 10 μm and/or up to about 500 μm, 850 μm, or 1000 μm). In other refinements, cellulosic materials can have a nanoscale size, for example having particle sizes ranging from about 1 nm to about 1000 nm (e.g., at least about 1 nm, 5 nm, 10 nm, or 20 nm and/or up to about 50 nm, 100 nm, 200 nm, 500 nm, or 1000 nm). Examples of suitable nanoscale cellulosic materials include cellulosic nanomaterials, which can be extracted from lignocellulosic materials by known mechanical and/or chemical methods. Cellulosic nanocrystals can have an approximate spherical shape or irregular shape with a low aspect ratio, and cellulosic nanofibers can be a high aspect ratio with a nanoscale diameter and a microscale length. A suitable cellulosic material includes a softwood pine wood flour. Pine wood flour and other relatively porous wood flour are particularly suitable for polymer blending.

The amount of cellulosic material incorporated into the pesticide plug or composite pesticide plug is not particularly limited. In refinements, the cellulosic reinforcement or material is present in an amount ranging from about 30 wt % to about 60 wt %, about 30 wt % to about 80 wt %, or about 60 wt % to about 99.9 wt %, based on the total weight of the pesticide plug or composite pesticide plug. For example, the composite pesticide plugs can include at least about 30, 35, 40, 45, 50, 55, 60, 65, or 70 wt % and/or up to about 40, 45, 50, 55, 60, 65, 70, 75, 80, 85, 90, 95, 98, 99, or 99.9 wt % of the cellulosic reinforcement or material, based on the total weight of the plug. The cellulosic material amount can include all cellulosic species combined when there is more than one type in the plug.

In refinements, the cellulosic material comprises one or more cellulose derivatives, for example in powder form, fiber form, etc. A cellulose derivative generally has one or more of its functional groups (e.g., native hydroxy groups) on glucose units of the cellulose chain replaced with one or more different functional groups. Selection of a particular cellulose derivative can improve or otherwise adjust one or more physical or chemical properties of the cellulosic material, such as water swellability, water solubility, etc. For example, in some instances the cellulose derivative can function to improve the release of active ingredients. The cellulose derivative (e.g., sodium carboxymethyl cellulose) completely dissolves in the presence of tree sap, thus providing improved release of active ingredients. Without wishing to be bound to any particular theory, it is believed that the complete dissolution of the cellulose derivative minimizes the risk of particulates plugging xylem tissues following trunk injection. In addition, the cellulose derivative also can function in healing the tree. In instances, where the cellulose derivative swells (e.g., due to the absorption of water) after trunk injection, the swelled cellulose derivative can form a gel-like consistency that expands to fill the bore hole leaving no air space in the cavity. Without wishing to be bound to any particular theory, it is believed that this leads to improved distribution of the plant protection material as well improved healing of the tree by filling the bore hole.

More generally, the cellulose derivative can include cellulose ethers with —OR substituents in place of some or all —OH groups in the cellulose backbone. R can be a substituted or an unsubstituted alkyl group, for example a C1, C2, C3, C4, C5, or C6 linear or branched alkyl group. The cellulose ethers can have one or more than type of substituting group R. The cellulose derivatives can be partially or fully substituted with degrees of substitution up to 3, for example at least 1, 1.2, 1.4, 1.6, 1.8 or 2 and/or up to 1.5, 1.7, 2, 2.3, 2.6, or 3. The degree of substitution represents an (average) number of —OH groups per glucose unit in the cellulosic chain that are replaced by one or more different —OR groups. Unsubstituted alkyl groups can include methyl, ethyl, propyl, isopropyl, butyl, isobutyl, tert-butyl groups, etc., for example a methyl group as in methyl cellulose and hydroxypropyl methylcellulose. Substituted alkyl groups can include hydroxylated alkyl groups, for example a hydroxypropyl group as in hydroxypropyl cellulose and hydroxypropyl methylcellulose. Substituted alkyl groups can include carboxylated alkyl groups and salts thereof (e.g., sodium salt), for example a carboxymethyl group as in carboxymethyl cellulose. Substituted alkyl groups can include aminated alkyl groups and salts thereof (e.g., chloride ammonium salt), such as a dialkylamine group as in diethylaminoethyl cellulose (DEAE-C).

In refinements, the cellulosic reinforcement or material includes a cellulose derivative selected from the group consisting of carboxymethyl cellulose (CMC) carboxymethyl hydroxyethylcellulose, hydroxyethyl cellulose (HEC), hydroxypropyl cellulose (HPC), hydroxypropyl methylcellulose (HPMC), hydroxyethyl methylcellulose (HPMC), ethyl hydroxyethylcellulose, methyl ethyl hydroxyethylcellulose, methyl cellulose (MC), ethyl cellulose (EC), ethyl methyl cellulose (EMC), diethylaminoethyl cellulose (DEAE-C), a salt thereof, and a combination thereof.

In refinements, the cellulose derivative is carboxymethyl cellulose.

In refinements, the carboxymethyl cellulose is sodium carboxymethyl cellulose.

### Plant Protection Material

The pesticide plugs of the disclosure contain one or more plant protection materials. Examples of general classes of plant protection materials include pesticides, biopesticides, plant growth regulators, and fertilizers. In some embodiments, mixture or other combinations of two or more different plant protection materials can be included in the plug.

In refinements including the thermoplastic polymer matrix, the plant protection material can be homogeneously distributed throughout the thermoplastic polymer matrix. For example, the plant protection material (e.g., biopesticide, pesticide, etc.) can be present as a miscible blend with the polymeric components of the plug matrix. Most common technical grade pesticides are naturally dry (or solid) materials at ambient room/environmental temperatures, and they can be combined directly in dry form with the other plug components, or they formulated as liquids (e.g., with a suitable solvent) for combination with the other plug components. In some refinements, for example without the thermoplastic polymer matrix, the plant protection material can be admixed with and/or bound to the cellulosic material, for example as a result of blending the plant protection material and cellulosic material along with a solvent to promote mixing, adsorption, absorption, etc. of the plug components.

Biopesticides are generally known in the art and can target one or more types of tree pests as do conventional chemical pesticides, but they are derived from natural materials such as animals, plants, bacteria, fungi, and certain minerals. Suitable nonlimiting examples of biopesticides include, for example, the group consisting of azadirachtin, peptides, fermentation by-products, fungal agents (e.g., Beauvaria), and combinations thereof. Biopesticides are preferably selected that are xylem-mobile (and optionally phloem-mobile), which facilitates their transport from the plug to the tree canopy or other surface tree tissue, and/or ingestion-active, which allows the biopesticide to act upon a target pest after ingestion by the pest. For example, the target pest can ingest biopesticide by consuming leaves or other plant tissue to which the biopesticide has been transported by xylem transport. Internal tree plug delivery and xylem transport of the biopesticide helps preserve the activity of the biopesticide, which typically is very sensitive to UV degradation. When the biopesticide is internally delivered and transported throughout the tree, it remains largely shielded from degrading UV radiation before it is consumed by the pest. In contrast, a biopesticide that is applied foliarly to the canopy or other exterior environmental surface of the tree can be subject to rapid UV degradation, or degradation due to soil microbes, prior to ingestion by the pest(s).

In refinements, the plant protection material includes a pesticide. In refinements, the pesticide can include one or more neonicotinoids, avermectins, diamides, sterol inhibitors, oxytetracycline, phosphorous acid, derivatives thereof, and combinations thereof. The pesticide is not particularly limited and can include any pesticides (e.g., insecticides, fungicides, miticides and/or antibiotics used for tree health) that target one or more tree pests and that are compatible with xylem (and optionally phloem) transport with a target tree. Xylem tissue within the tree trunk, branches (e.g., scaffold branches, lateral branches), stems, leaves, etc. provides a transport path for water from the roots, through the trunk, branches, stems, etc., and to the leaves. Naturally transported water through the xylem tissue provides a vehicle for transport and delivery of the pesticide or other plant protection material from the plug. Similarly, phloem tissue within the tree provides transport for water-soluble sugars and can assist in pesticide delivery as well. Suitable classes of pesticides include neonicotinoids, avermectins, diamides (e.g., diamide insecticides), sterol inhibitors (e.g., sterol inhibitor fungicides), oxytetracycline (e.g., a tetracycline group antibiotic), phosphorous acid, derivatives thereof, and combinations or mixtures thereof. Example derivative forms include salts such as metal salts (e.g., alkali and/or alkali earth metal salt) and amine salts (e.g., as mono-, di-, or tri-alkyl or alkanol amine; amine salt with a halogen such as chloride or a carboxylate such as benzoate), esters (e.g., alkyl esters), and amides. Example neonicotinoids include acetamiprid, clothianidin, imidacloprid, nitenpyram, nithiazine, thiacloprid, and thiamethoxam. Example avermectins include ivermectin, selamectin, doramectin, abamectin, and emamectin (a 4″-deoxy-4″-methylamino derivative of abamectin, such as in the form of a benzoic acid amine salt). Example diamides include broflanilide, cyantraniliprole, flubendiamide, and chlorantraniliprole. Example sterol inhibitors include triazole fungicides (e.g., tebuconazole, propiconazole), imidazoles (e.g., imazalil), and pyrimidines (e.g., fenarimol).

Although generally described herein for use in combination with and for delivery of a biopesticide or pesticide plant protection material, the pesticide plug or composite pesticide plug can more generally include any active ingredient other than or in addition to biopesticides and/or pesticides for delivery to internal tree tissue. Examples of any of the various plant protection materials known in the art for promoting tree health, such as materials which kill or inactivate tree pests, increase a tree's resistance to pests, and/or promote tree growth, etc. can be used. Plant protection materials can include pesticides (e.g., as described above), biopesticides (e.g., as described above), plant growth regulators, and fertilizers, for example. The composite pesticide plugs can include multiple different types of plant protection materials, for example two or more plant protection materials of the same or different type (e.g., two different types of pesticide, one pesticide and one fertilizer, etc.). Plant growth regulators are generally known in the art and can include various synthetic or natural substances that stimulate or otherwise regulate plant growth in a manner or mechanism similar to that of natural plant hormones. Fertilizers, whether specifically tailored for trees specifically or plants more generally, are generally known in the art and can include one or more plant nutrients such as macronutrients (e.g., nitrogen, phosphorus, potassium, calcium, sulfur, and/or magnesium) or micronutrients (e.g., trace minerals such as boron, chlorine, manganese, iron, zinc, copper, molybdenum, nickel, and/or cobalt) desired to supplement the nutrients from the tree's local soil environment. As used herein, description related to pesticides is understood to apply more generally to any active ingredient or plant protection material for inclusion in the composite plug (e.g., present in the thermoplastic polymer matrix such as being homogeneously distributed throughout the matrix).

In refinements, the plant protection material (e.g., biopesticide, pesticide, etc.) is present in the pesticide plug or composite pesticide plug in an amount ranging from about 10 wt % to about 30 wt %, or about 0.1 wt % to about 40 wt %, based on the total weight of the pesticide plug or composite pesticide plug. For example, the plant protection material can be present in an amount of about 0.1, 1, 2, 5, 10, 12, 15, 17, 20, 22 or 25 wt % and/or up to about 5, 8, 12, 15, 17, 20, 22, 25, 27, 30, 35, or 40 wt %, based on the total weight of the plug. The foregoing amounts can be expressed on a wet- or dry-weight basis for the plug, for example before or after any water or other liquid solvent in the thermoplastic polymer medium has evaporated and the plug has solidified.

In some refinements, the plant protection material can include (or further include) a dsRNA plant protection material, wherein the dsRNA has a nucleotide sequence selected to target one or more target tree pests via an RNA-interference (RNAi) mechanism. The dsRNA for a given plug can be selected to have a specific sequence such that the dsRNA, when taken up by a target pest, is cleaved and unwound such that the ssRNA fragments can suppress or eliminate mRNAs in the target pest via an RNA interference (RNAi) mechanism. RNAi involves gene suppression by introducing dsRNAs that undergo a “processing pathway” in the cell, that can emanate internally within a target organism cell, subsequently suppressing or eliminating the specific mRNAs in the targeted species required for normal function. As described above for other plant protection materials, once injected into a tree, xylem transport within the tree can transport the dsRNA to the tree canopy and other tree tissues where the dsRNA can be consumed by the target pest to kill or control the pest. Internal tree plug delivery and xylem transport of the dsRNA can help to preserve the activity of the dsRNA, which is typically very sensitive to UV degradation. When the dsRNA is internally delivered and transported throughout the tree, it remains largely shielded from degrading UV radiation before it is consumed from the pest. In contrast, a dsRNA that is applied foliarly to the tree canopy of other exterior environmental surface of the tree can be subject to rapid UV degradation prior to ingestion by the pest. Moreover, by internally delivering and transporting the dsRNA throughout the tree, the dsRNA is not exposed to soil microbes that can also degrade the dsRNA.

### Methods for Plant Protection Material Delivery

In another aspect, the disclosure relates to methods for delivering a plant protection material to a tree, the method including inserting the plugs of the disclosure into an interior trunk region of a live tree.

The pesticide plug or composite pesticide plug according to any of its variously disclosed embodiments can be used to deliver a relatively uniform, consistent amount of its one or more plant protection materials to internal tree tissue over time to tree tissue at or above the plug's point of insertion into the tree. When present, the thermoplastic polymer in general (e.g., PVAc or otherwise) can provide mechanical strength to the plug to maintain its shape during storage, transport, and tree insertion. The water-soluble nature of the water-soluble thermoplastic polymer (when present) assists in pesticide release and aqueous delivery of the pesticide via xylem (and optionally phloem) transport. The biodegradable nature of the biodegradable thermoplastic polymer (when present) and the cellulosic material assists in healing of the tree after insertion of the plug. The plug is inserted into an interior region of a live tree (e.g., into the trunk, one or more branches, etc.) in a suitable number and at a suitable position (e.g., a suitable height above ground) in the tree. After insertion, natural water and/or sap transport within the tree will release and deliver the one or more plant protection materials to internal tree tissue from the plug. Inserting the plug can involve drilling a hole in the tree trunk with a diameter generally corresponding to that if the plug and a desired depth, and then inserting the plug into the hole. The manner of plug insertion is not particularly limited, however, and any suitable mechanical means may be used (e.g., a mechanical device or tool that can insert the plug with or without the use of a drill). The length of the plug and its insertion depth into the trunk are generally selected to provide maximum exposure of the plug's outer surface area to active xylem and/or phloem tissues, which are immediately under the bark of the tree. Suitable depths can be determined by the skilled artisan based on the type and size of tree for injection.

The pesticide plug or composite pesticide plug is generally inserted into a lower portion of the tree trunk, typically between the ground and the first set of scaffold limbs or branches above the ground. Injection at such point ensures that xylem transport of the pesticide will reach most or essentially all plant tissue above the insertion point, given that xylem transport of water initiates at the roots and travels upwards to the plant tissue extremities. By way of non-limiting example for various common trees of interest, the composite pesticide plug can be inserted at a height ranging from 0.1 m to 1 m above the ground (e.g., a height of at least 0.1 or 0.2 m and/or up to 0.3, 0.5, or 1 m). In apple trees, for example, the first set of scaffold limbs occur at or above about 0.3 m, so an insertion point below 0.3 m is desirable. In embodiments, the method includes inserting the composite pesticide plug at a height ranging from about 0.1 m to about 1 m above ground, for example at least about 0.1, 0.2, 0.25, 0.3, 0.4, 0.5, 0.6, or 0.7 m and/or up to 0.4, 0.5, 0.6, 0.7, 0.75, 0.8, 0.9, or 1.0 m above ground.

For a given tree, multiple pesticide plugs or composite pesticide plugs are suitably inserted into the tree at multiple positions distributed around the tree trunk (e.g., circumferentially distributed). The total number of plugs for a given tree increases as the trunk diameter increases. Larger trees need more active ingredient because they have more canopy. Xylem is sectored within the tree such that multiple plugs are needed to attain an even distribution of product in the tree canopy. For example, 2, 3, 4, 5, 6, 8, 10, 12, 15, 20, or more plugs can be distributed around the circumference of the tree trunk at approximately even intervals (e.g., at approximately 360°/n intervals where n is the number of plugs inserted into the tree trunk).

In embodiments, the method includes inserting a plurality of the pesticide plugs or composite pesticide plugs distributed circumferentially around the tree trunk. For example, at least 2, 3, 4, 5, 6, or 7 and/or up to 5, 6, 7, 8, 9, or 10 plugs can be inserted into the tree trunk. The plurality of composite pesticide plugs can be distributed evenly around the circumference of the tree trunk, such that the distance between each of the plurality of plugs is the same. Alternatively, or additionally, the plugs can be arranged in clusters of plugs (e.g., at least 2 3, or 4 and/or up 3, 4, or 5 plugs), and the clusters of plugs can be distributed evenly around the circumference of the tree trunk, such that the distance between each of the clusters is the same. The plurality of plugs (or clusters thereof) can be arranged at the same height (e.g., above ground), or at various heights.

The types of trees that can be treated with the pesticide plugs or composite pesticide plug are not particularly limited and can be trees in a cultivated area (e.g., orchard), a nursery, or a wild area (e.g., forest), for example. Suitable types of trees include fruit trees, ornamental trees, forest trees, etc. Examples of specific fruit trees of interest include apple trees, cherry trees, grapefruit trees, lemon trees, lime trees, nectarine trees, orange trees, peach trees, pear trees, plum trees, and pomegranate trees. In embodiments, the tree is a fruit tree such as one or more of apple trees, cherry trees, grapefruit trees, lemon trees, nectarine trees, orange trees, peach trees, pear trees, plum trees, and pomegranate trees.

### Methods of Preparing Pesticide Plugs

In another aspect, the disclosure relates to a method of preparing the composite pesticide plug as described herein. The method generally includes admixing the thermoplastic polymer, the cellulosic reinforcement or material, and the plant protection material to provide the composite pesticide plug. The admixing is performed at a temperature of about 5° C. to about 30° C., of about 10° C. to about 30 ° C., or about 15 ° C. to about 30° C. For example, the admixing can be performed at a temperature of at least about 5, 10, 15, 20, 22, or 25° C. and/or up to about 22, 25, 27, or 30° C. The thermoplastic polymer is suitably a polymer such as polyvinyl acetate that can solidify and form a solid polymer matrix at low temperatures to avoid inactivation or other degradation of the plant protection material. In refinements, the method is free of a heat extrusion process (e.g., melt blending). More generally, the method does not involve thermal or melt processing, whether by extrusion, molding, etc. Suitably, from the initial admixing of the separate components to the final (dried/solid) plug, the components are not exposed to temperatures above about 30, 50, 70, 90, or 120° C.

In another aspect the disclosure relates to a method of preparing the pesticide plugs described herein when the pesticide plug does not include a thermoplastic polymer matrix. In these embodiments, the method comprises admixing the cellulosic reinforcement or material and the plant protection material to provide a pesticide plug. The admixing is performed at a temperature of about 5° C. to about 30° C., for example, about 10° C. to about 30° C., or about 15° C. to about 30° C. For example, the admixing can be performed at a temperature of at least about 5, 10, 15, 20, 22, or 25° C. and/or up to about 22, 25, 27, or 30° C. In refinements, the method is free of a heat extrusion process (e.g., melt blending). More generally, the method does not involve thermal or melt processing, whether by extrusion, molding, etc. Suitably, from the initial admixing of the separate components to the final (dried/solid) plug, the components are not exposed to temperatures above about 30, 50, 70, 90, or 120° C.

In refinements, the admixing further includes adding at least one liquid (e.g., water, organic solvent, etc.) to the thermoplastic polymer (when present), the cellulosic reinforcement, and the plant protection material to form a moldable mixture therefrom. The method further includes drying the moldable mixture to remove at least some (e.g., all or substantially all) of the liquid, thereby forming the pesticide plug or composite pesticide plug.

While the disclosed pesticide plugs and composite pesticide plugs and methods are susceptible of embodiments in various forms, specific embodiments of the disclosure are illustrated (and will hereafter be described) with the understanding that the disclosure is intended to be illustrative, and is not intended to limit the claims to the specific embodiments descried and illustrated herein.

### EXAMPLES

The following examples illustrate the pesticide plugs and composite pesticide plugs, related methods for forming the plugs, and related methods for delivering plant protection materials disclosed herein, but are not intended to be limiting.

The following abbreviations are used in the Examples: Al refers to active ingredient; ddPCR refers to droplet digital polymerase chain reaction; RLT refers to a lysis buffer; DFH refers to trunk diameter at one foot (about 30 cm) above ground; UTC refers to untreated control; rcf refers to relative centrifugal force; PVOH refers to polyvinyl alcohol; PVA refers to polyvinyl acetate; DAT refers to days after treatment; LC-MS refers to liquid chromatography mass spectrometry; LC-MS/MS refers to liquid chromatography mass spectrometry/mass spectrometry.

The following illustrates a process for preparing plugs according to embodiments of the disclosure.

### Azadiractin Plug Formulation and Method

The staring materials were dry. Azadiractin (3.8 g) and cellulose (9.8 g) were combined and mixed thoroughly to form dry mixture. To the mixture was added generic polyvinyl acetate-based school glue (6.5 g) with mixing. To this mixture was added ethanol (1.6 mL) with mixing. The ethanol containing mixture was placed in a 3 mL luer-lock tip syringe. The plugs were allowed to dry in a vent hood for 3-5 days. After drying, the plugs were removed from the syringe (e.g., using a plunger) and cut to the desired length.

### Imidacloprid Plug Formulation and Method

A similar procedure was followed using the following components: imidacloprid (6.7 g); cellulose (14 g); generic polyvinyl acetate-based glue (9.3 g); ethanol (1.8 mL).

Process for Cellulose-dsRNA Plugs

A manufactured dsRNA stock solution of at least 10 mg/mL was obtained as a viscous aqueous solution. The dsRNA was concentrated from the aqueous solution by adding 1/10 volume of 3 M sodium acetate (pH 5.2) and 2 volumes of EtOH followed by pelleting down the precipitate by centrifugation at 4,000 rpm for 10 minutes. The clear EtOH/salt buffer solution was decanted from the tube leaving the intact dsRNA pellet at the bottom of the tube. Cellulose powder (1 g) was mixed into the dsRNA pellet (containing at least 100 mg of dsRNA) followed by addition of 200-300 μl of the decanted EtOH/salt buffer solution until a homogenous dough mixture was obtained. This final plug mixture consisting of dsRNA pellet-cellulose powder was molded into a 5 mL syringe—with the plunger removed. The syringe containing the plug was allowed to dry (e.g., under a chemical fume hood 5 days). Upon drying for 5 days, the molded dried plug detached from the syringe and was transferred to a sealed container (e.g., a plastic bag) with a dessicant and stored at 4° C.

### Process for Cellulose-dsRNA-PVA Plugs

A manufactured dsRNA stock solution of at least 10 mg/mL was obtained as a viscous aqueous solution. The dsRNA was concentrated from the aqueous solution by adding 1/10 volume of 3 M sodium acetate (pH 5.2) and 2 volumes of EtOH followed by pelleting down the precipitate by centrifugation at 4,000 rpm for 10 minutes. The clear EtOH/salt buffer solution was decanted from the tube leaving the intact dsRNA pellet at the bottom of the tube. Cellulose powder (1 g) was mixed into the dsRNA pellet (containing at least 100 mg of dsRNA) followed by addition of 200-300 μl of the decanted EtOH/salt buffer solution until a homogenous dough mixture was obtained. This final plug mixture consisting of dsRNA pellet-cellulose powder was molded into a 5 mL syringe—with the plunger removed. The syringe containing the plug was allowed to dry (e.g., under a chemical fume hood 5 days). Upon drying for 5 days, the molded dried plug detached from the syringe and was transferred to a sealed container (e.g., a plastic bag) with a dessicant and stored at 4° C.

### Cellulose Powder Plug

Cellulose powder (0.6 g) (Type 101, Sigma Aldrich, Milwaukee, WI) was loaded in a sterile 3 mL plastic syringe (Becton Dickinson Co. Franklin Lakes, NJ) (used as a spin-column) with the bottom surface lined with 3 layers of sterilized cotton filter paper (#41, cut to size) (Whatman, Vernon Hills, IL). The syringe plunger was discarded. The syringe rested on a 15 mL conical tube (Corning RNAse-free, Cole-Palmer, Vernon Hills II.) which collected the flow-through from each centrifugation step. A solution of 7-8 mg dsRNA in 4 mL of RNAse-free water was prepared. One mL of 5×MES-buffered saline (ph=6.5; Alfa Aesar) was added to the dsRNA solution. After mixing the dsRNA/saline solution, 1 mL of 100% ethanol was added to it to provide a final concentration of 16% (v/v). The cellulose powder in the syringe was first primed with the addition of 2 mL of 1×MES-buffered saline containing 16% (v/v) ethanol and centrifuged at 3000-4000 rpm for 2-3 min. The dsRNA-binding buffer mixture was then applied to the syringe column 2 mL at a time and centrifuged at 3000-4000 rpm for 3 min each round of binding (required 3 rounds to run the total volume of buffer). The flow-through was discarded after each centrifugation. After the binding steps, a drying spin was performed at 5000 rpm for 10 minutes. The cellulose powder with bound dsRNA was further air-dried in the syringe under a chemical fume hood for another 10 min. The syringe containing the cellulose powder with dsRNA was then stored at 4° C. in a sealed bag (e.g., ziplock bag) with dessicant pouches to maintain integrity. The amount of bound dsRNA per 0.6 gram of cellulose powder was estimated to be approximately 1.6 mg.

### Laboratory Dissipation Studies

For laboratory dissipation studies, plugs containing 1-20 mg (each) of dsRNA were placed in each of three replicate 50 mL RNAse-free conical tubes, and 35 mL of nuclease-free water added to each container and closed. After each sampling interval, the solution was removed and a fresh 35 mL of water added to each sample container. An aliquot of each sample solution was analyzed using the NANODROP (ThermoFisher Scientific; Waltham, MA) spectrophotometer to determine nucleic acid concentration, and agarose gel electrophoresis was used to determine integrity of the dsRNA band (for concentrations applicable to this technique).

### Field Trial 1 Methods

Field studies were initiated to determine if dsRNA can be delivered to apple tree canopy foliage, comparing three controlled-release plugs, with and without the addition of water, to a liquid formulation using a commercial trunk injection tool (e.g., ARBORJET QUICKJET). The dsRNA and dosage parameters are provided in Table 1. Treatment injections were made to semi-dwarf Yellow Delicious apple trees (6 inch or about 15 cm DFH) on 20 May (tight cluster/pink stage of apple phenology), with eight injection ports per trunk and approximately one foot (or about 30 cm) above the ground, replicated four times.

Field samples were taken from injected trees for each treatment by collecting leaves 3, 14, 35, 56, 84 days after treatment (DAT). The leaf samples were a minimum of 40 leaves (±20 g) of tissue collected from the N, S, E, W sides of the tree, high/low, and delivered in a cooler on the same day to the laboratory. Leaf samples were placed in a mortar (mortar and pestle that has been pre-chilled in −80° C. freezer), and leaves ground to a fine powder with pestle after submersing in liquid nitrogen. Label sample vials and autoclaved 2 mL sample vials were held in −80° C. freezer until filled with 1-2 g of leaf powder, two sub-samples per treatment and replicate. Sample vials were stored at −80° C. until shipping to an RNA analysis laboratory in dry ice for quantification. Recovery data was recorded and graphically displayed to compare temporal delivery patterns across treatments.

TABLE 1
Field Trial 1 Treatment

| | | | | Application |
|---|---|---|---|---|
| | | Plugs | dsRNA | Method¹ |
| ID | Sample | (per tree) | (g/tree) | (per tree) |
| TR1 | UTC | | | |
| TR2 | QUICKJET dsRNA | | 1 | 8 ports; 400 mL |
| | liquid | | | water |
| TR3 | dsRNA cellulose- | 4 | 1 | 8 plugs, 9.5 mm |
| | PVA plug | | | dia., drill |
| TR4 | dsRNA cellulose | 4 | 1 | 8 plugs, 9.5 mm |
| | plug | | | dia., drill |

¹Each treatment has four replicates, with one tree representing one replicate.

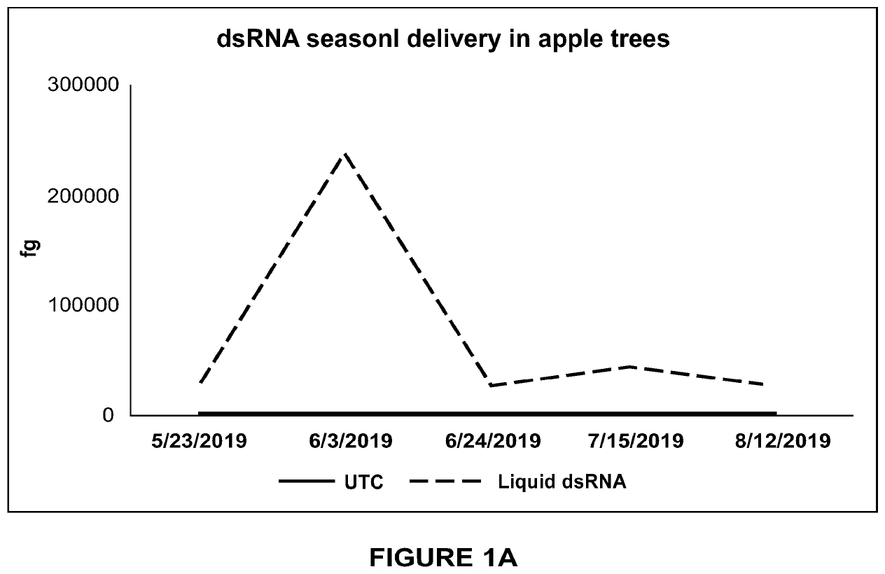

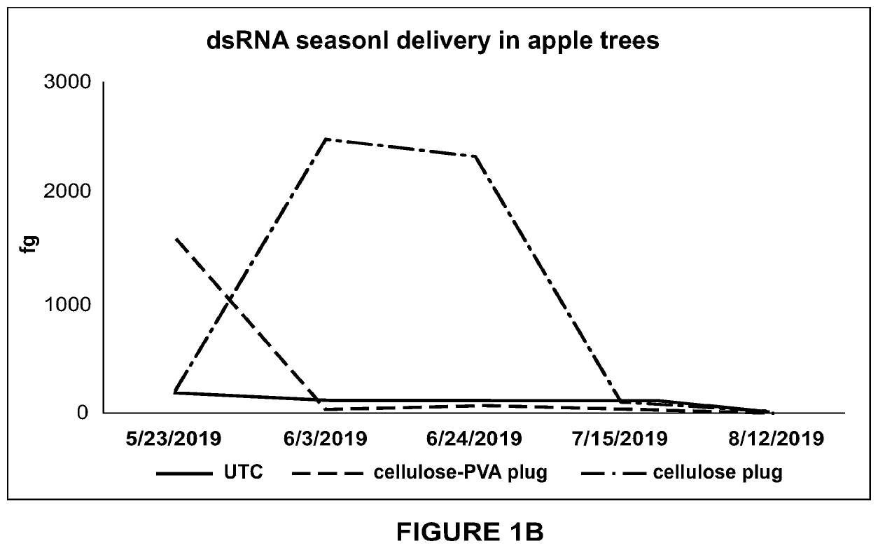

The dsRNA delivered in the tree was quantified using PCR. The results are summarized in FIGS. 1A and 1B. Polymerase chain reaction (PCR) results showed that the liquid formulation of dsRNA delivered the highest concentrations to the tree canopy, peak levels reaching approximately 250,000 fg, or 10 ng/1 g leaf tissue (average apple leaf is 0.5 g) (FIG. 1A). The dsRNA plug injections according to the disclosure resulted in lower concentrations in the canopy, peak levels reaching 2,500 fg, or 100 pg/1 g leaf tissue (FIG. 1B). Even though the plugs delivered less dsRNA to apple leaves, there was positive evidence for controlled release.Mite Bioassays

The collection of the apple leaves from the field was conducted at five different times: 3, 14, 35, 56, and 84 days after treatment (DAT). The apple leaves were put in a cooler and delivered to laboratory on the same day. Upon arrival in the laboratory, the leaves were cut into leaf discs and put into a plastic cup containing 1.5 % agar (NEOGEN culture media, ACUMEDIA), and the assay was conducted on the following day.

### Leaf Disc Bioassays

Leaf disc method was used on all the assays in this study. In summary, five to ten apple leaves were collected from each replicate tree. A leaf disc (1 cm diameter) was cut from each leaf and put into a suitable container with agar (e.g., plastic cup having 4.8 cm in diameter, 2 cm high, 44 mL in volume containing 20 mL of 1.5% agar). The leaf disc was put upside down on the agar as mites usually feed on the underside of the leaves. In this instance, each plastic cup had five leaf discs placed in the middle zone of the agar in the cup and arranged in a way that they did not touch each other. Then, the agar on the peripheral zone was cut and removed, and distilled water was added to serve as a barrier. This water barrier surrounding the agar was aimed to preventing the mites from escaping or moving off the leaf discs. Then the cup was covered with its lid that was poked with insect pin to have 15 holes for aeration.

### Assays on Adult Female Mites

Adult females were collected from the mite colony. To that end, leaves were cut from the bean plants and female mites were collected with a small brush under a microscope and transferred onto the leaf discs. Females were checked after the transfer to make sure they were healthy, and injured females were replaced. Two adult females were put on each leaf disc; thus, a plastic cup with five leaf discs contains ten females. Each plastic cup represents one replicate. The plastic cups were placed on a tray and put in the insectary facility at 25° C. and 16L:8D h photoperiod. The mortality of the mites was monitored daily for five days. Mites were considered dead when they did not respond to a poke with a thin paint brush. The tests were conducted on the five leaf sampling dates (3, 15, 35, 56, and 84 DAT). Each test had four treatments (TR1, TR2, TR3, TR4). Each treatment had four replicates with 10 adult females in each.

### Assays on Early Stage of Mites

Assays were also performed on mites exposed to the treated leaves since an early stage of their development. These tests were conducted on the last four sampling dates (14, 35, 56, and 84 DAT) after no effect on adults was observed on the 3 DAT assay. The procedures of each assay were slightly different form one another depending on the objective of the tests and the health of the leaf discs. All the assays started by collecting adult females from the colony. These females were allowed to lay eggs on the apple leaf discs for 24 h or 48 h and then were removed. The cup containing the eggs on the leaf discs was held in the insectary facility (at 25° C. and 16L:8D h photoperiod). Eggs were checked daily for hatchability, which occurred three to four days after egg deposition.

### 84 DAT Assay

For the assay on 84 DAT, two adult females were collected and allowed to lay eggs on each leaf disc before being removed after 24 h. Eggs were checked daily for hatchability. Only two newly hatched larvae were allowed to grow on each disc and the remaining larvae were removed with an insect pin. Mites that hatched at the same time were selected to ensure all mites are at the same age. Mites were monitored daily until their death. To this end, leaf discs were replaced when they started to turn brown which occurred after seven to ten days. Thus, apple leaves used at the beginning of the assays were stored in the refrigerator at 4° C. These apple leaves were used to replace the corresponding leaf discs that started to decay. The two individual mites placed on the same leaf discs were separated when they become adults. The individual mite that emerged first as adult was transferred to a new leaf disc. This separation was to enable the monitoring of the longevity and fecundity of each single emerged adult female. Decayed leaf discs were replaced with discs cut from new apple leaves collected from the field one week after the beginning of the assay.

The mite survivorship was compared on days 5, 10, and 15 after egg hatching. Typically, after day 15, most of the surviving mites become adults; and the number of emerged adults, the longevity and fecundity of emerged adult females were recorded. The assays had four treatments (TR1, TR2, TR3, TR4). Each treatment contained four replicates and each replicate was started with 10 newly hatched larvae. However, the untreated TR1 has three replicates only; leaves from one of the TR1 replicates did not support the development of the mite larvae and had to be removed. Each replicate was started with 10 newly hatched larvae.

### Results and Statistical Analysis

Generalized linear models (GLM) were used to estimate the effect of treatments on mites. GLM with binomial distribution was used for the analysis of data on immature survivorship, adult mortality and adult emergence; whereas GLM with poisson distribution was performed for data on adult female longevity and fecundity. GLM with quasibinomial and negative binomial distribution was used when data are overdispersed. Multiple comparison with Tukey's test was conducted if there is a significant difference among treatments. All tests were performed using the software R (version 3.6.1).

3, 14, 35 and 56 DAT Assays: Results for adult female mite and juvenile assays indicate no difference in mite mortality or survivorship.

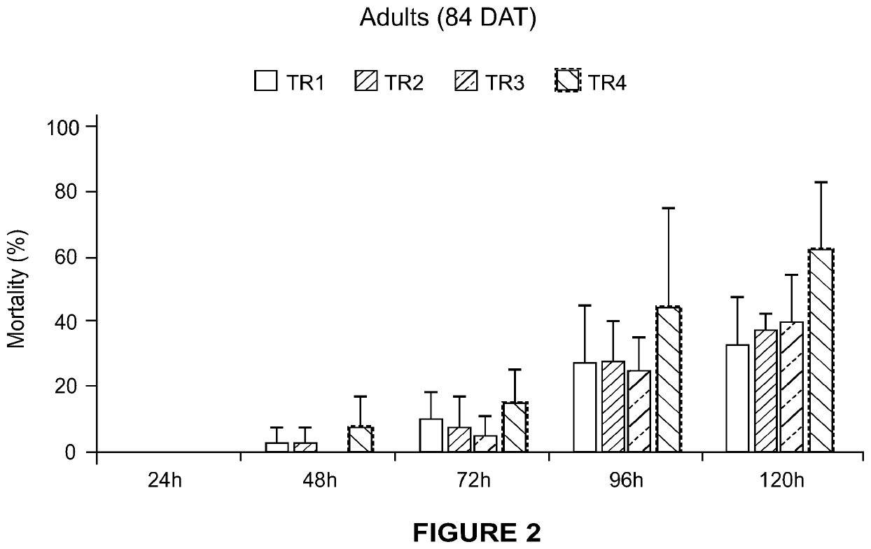

84 DAT Assays: Adult female mites were exposed for five days to the treated leaves collected 84 DAT. No difference in mortality was observed among treatments at 48, 72, and 96 h (F(3,12)=1.11, p=0.38; F(3,12)=1.00, p=0.42; F (3,12)=0.94, p=0.45, respectively) (FIG. 2). No asterisk (*) indicates no significant difference between treated and untreated mites according to Tukey's test at p<0.05. The mortality in treatment TR4 (62.5%) appeared to be higher compared to that in the untreated control TR1 (32.5%) at 120 h; however the statistical analysis indicated no difference among treatments (F(3,12)=3.2, p=0.06).

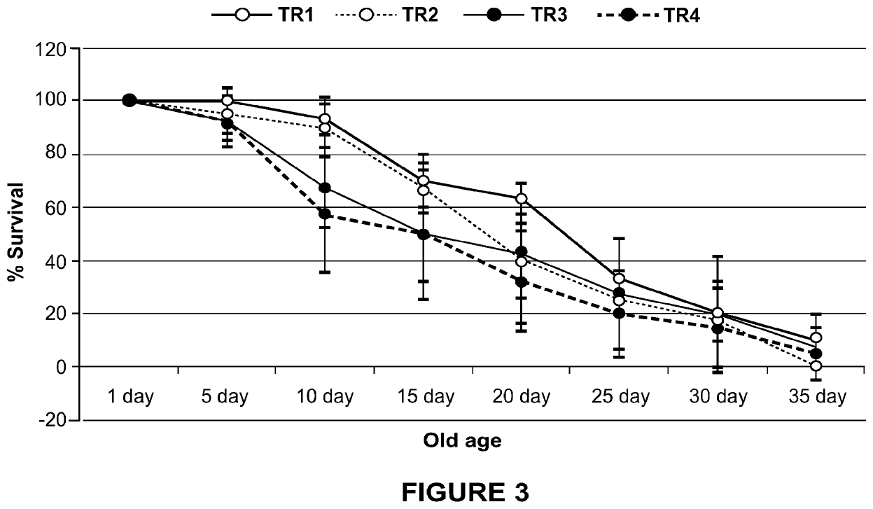

Mites were also exposed to the treated leaf discs since egg stage and the survivorship of the hatched mites was monitored until their death. Each replicate had 10 individual mites. No difference in survivorship was observed among the four treatments 5 and 15 days after egg hatching (F(3,11)=0.69, p=0.57; F(3,11)=1.45, p=0.28). In contrast, the statistical analysis indicates a significant difference among treatments after 10 days (F(3,11)=4.68, p=0.02). The follow up Tukey's test shows that the percent survival of mites in the treatment TR4 (57.5%) was significantly lower compared to that in the untreated control TR1 (93.3%) (p=0.01); a significant difference was also observed between treatment TR4 and treatment TR2 (p=0.01) (FIG. 3).

The adult emergence of these mites exposed to the treated leaves since egg stage was also studied. The mean percentage of emerged adults in treatment TR4 appeared to be lower compared to that of the untreated control (42.5% and 73.3% respectively) (Table 2), however, the data analysis indicated no statistical difference among the four treatments (F(3,12)=1.62, p=0.24). Similarly, there was no statistical difference in the longevity and fecundity of the emerged adult females among the four treatments (F(3,58)=0.87, p=0.46; (F(3,58)=1.06, p=0.36). (Table 2).

TABLE 2
Summary of adult mites emerging from individual mites exposed
since egg stage to apple leaves treated with dsRNA (84 DAT).

| | Emerged adults (84 DAT) | | |
|---|---|---|---|
| | | Mean Adult Female | Mean |
| | % Emerged Adults | Longevity | Eggs per |
| Treatment | (males and females) | (day) ± SD | Female ± SD |
| TR1 | 73.3 ± 11.5 | 12.1 ± 7.2 | 5.7 ± 3.8 |
| TR2 | 60.0 ± 25.8 | 11.3 ± 6.4 | 4.8 ± 5.3 |
| TR3 | 50.0 ± 18.3 | 13.0 ± 7.2 | 5.2 ± 4.3 |
| TR4 | 42.5 ± 17.0 | 15.3 ± 6.5 | 8.0 ± 6.1 |

No asterisk indicates no significant difference between treated and untreated mites according to Tukey's test at p < 0.05; (TR1: untreated control, TR2: dsRNA liquid, TR3: Cellulose- dsRNA-PVA plug, TR4: cellulose-dsRNA plug

### Field Trial 2 Methods—Imidacloprid and Azadirachtin Plugs in Pear Trees

Field studies were conducted to determine if insecticides can be delivered to pear tree canopy foliage, comparing composite pesticide plugs in accordance with embodiments of the disclosure to liquid formulations. The composite plugs were formulated to match the labeled rates on a per tree basis (Table 3). Plug injections were made to Bartlett pear trees at the tight cluster stage of pear phenology, with four injection ports per trunk and approximately 1 ft (or about 30 cm) above the ground, replicated four times. Sample ID TR1 was an untreated control. Sample IDs TR2 and TR3 were commercial formulations of azadirachtin and imidacloprid, respectively. Sample ID TR4 was a composite pesticide plug including cellulose as the cellulosic material, polyvinyl acetate (PVA) as the thermoplastic polymer, and azadirachtin as the plant protection material. Sample ID TR5 was a composite pesticide plug including wood flour as the cellulosic material, polyvinyl alcohol (PVOH) as the thermoplastic polymer, and imidacloprid as the plant protection material. Sample ID TR6 was a composite pesticide plug including cellulose as the cellulosic material, polyvinyl acetate (PVA) as the thermoplastic polymer, and imidacloprid as the plant protection material.

TABLE 3
Pear Tree Field Trial

| | | | Dose | | Active | |
|---|---|---|---|---|---|---|
| ID | Sample | Active | (per tree) | | (per tree) | |
| TR1 | UTC | — | — | | — | |
| TR2¹ | AZASOL 6% | azadirachtin | 4 | g² | 0.24 | g |
| TR3¹ | Imijet | imidacloprid | 16 | mL² | 0.8 | g |
| TR4 | 60:40 (w/w) cellulose:PVA | azadirachtin | 4 | plugs² | 0.24 | g |
| TR5 | 60:40 (w/w) wood:PVOH | imidacloprid | 4 | plugs² | 0.8 | g |
| TR6 | 60:40 (w/w) cellulose:PVA | imidacloprid | 4 | plugs² | 0.8 | g |

¹in 500 mL water solution;
²0.25 in. (6.4 mm) dia, drill

Field control evaluations were made by collecting residue samples taken from injected trees for each treatment by collecting leaves 7, 14, 28, and 56 days after treatment (DAT). The leaf samples included a minimum of 40 leaves (±20 g) of tissue collected from the N, S, E, W sides of the tree, high/low and held in labeled sealed bags (e.g., plastic bags). Leaf samples were stored with dichloromethane in residue bottles, and taken to an analytical laboratory for high performance liquid chromatography (HPLC) analysis. Each sample was ground, then 10 g of sample taken and placed into a clean labeled sample jar. Next the samples were decanted through 10-25 g OF reagent-grade anhydrous sodium sulfate (EMD Chemicals, Inc.) to remove water. The samples were dried by evaporation under a chemical hood and the remaining particles brought back up with 2 mL of acetonitrile. The final 2 mL were transferred to a 2 mL vial (Agilent Technologies) for HPLC analysis. Residue levels were quantified using HPLC (e.g., Waters 2695 separator module HPLC equipped with a Waters MICROMASS ZQ mass spectrometer detector (Waters, Milford, MA)), and a C18 reversed phase column (50×3.0 mm bore, 3.5 μm particle size). Residue analysis were done using the QuEChERS method. Compounds were quantified using a standard curve, and recovery data were recorded as micrograms of active ingredient per gram (ppm) of plant tissue.

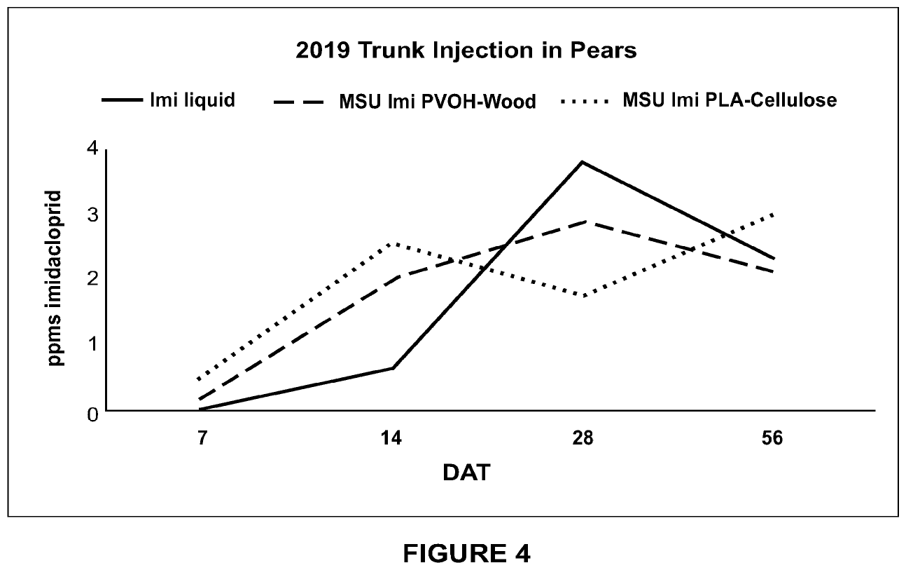

Azadirachtin plugs did not deliver to the tree canopy at quantifiable levels, but they were injected at a relatively late timing; further experimental results below indicate that azadirachtin and other plugs provide better release with an injection timing corresponding to early sap flow in the tree. Imidacloprid plugs delivered active ingredient to the tree canopies equivalent to that of the liquid imidacloprid formulation. In addition, the plugs showed positive evidence for controlled release (FIG. 4).

### Field Trial 3 Methods—Imidacloprid Plugs in Potted Apple Trees

This example demonstrates a preparation method for and use of a pesticide plug of the disclosure containing imidacloprid and cellulose or sodium carboxymethyl cellulose. Although no thermoplastic polymer matrix was included in the plugs for this example, a suitable thermoplastic polymer according to the disclosure (e.g., polyvinyl acetate or otherwise) could be added to the imidacloprid and cellulosic material to form a composite pesticide plug having improved mechanical strength while still providing controlled release of the imidacloprid.

### Pesticide Plug Preparation

Two hundred milligrams (0.2 g) of imidacloprid (95% technical grade, Kerde Chemical Co., Anhui, China) was added to cellulose powder (0.8 g) (Eisen-Golden Lab type 101, highly purified, fibers) or sodium carboxymethyl cellulose powder (0.8 g, 99%, food grade). Then ethanol (0.8 mL) (200 Proof Pure) was added with mixing to form a dough-like mixture. A disc of Whatman 41 filter paper (5 mm in diameter) was cut and put into the bottom of a luer lock tip 1 ml-syringe. The dough-like mixture was then transferred into two 1 mL syringes to the 8 mL mark. The syringe was placed under a fume hood for 3 to 5 days to allow the mixture to dry forming a solid plug.

### Injection and Treatment Amount of Imidacloprid

After drying, the pesticide plugs were pushed out of the syringe. Then 0.25 inch (about 6.4 mm) miniplugs were cut from the 1 g-batch plug. Given that the prepared 1g batch plug was enough to make sixteen 0.25 inch-miniplugs, each 0.25 inch-miniplug used in this example contains 12.5 mg imidacloprid. The miniplugs were then introduced into the potted apple tree trunks, with one miniplug per tree giving a rate of 12.5 mg imidacloprid per tree. The injection was conducted on June 11. Potted apple trees (150-175 cm in height and 2.2-3.4 cm of diameter at the base) grown in a greenhouse were used. For the injection method, a port of 0.25 inch (about 6.4 mm) in depth was formed with a 0.25 inch (about 6.4 mm) wood drill bit at 8 to 17 cm from the base of the potted apple trunk. The cellulose or sodium carboxymethyl cellulose pesticide plugs were put into the drilled hole, then 200 μL of apple sap was added.

Imidacloprid in liquid form was also used in the example as a comparison. Imidacloprid (95% technical grade) was mixed thoroughly with 500 μL of distilled water, giving a final rate of 12.5 mg imidacloprid per tree. The imidacloprid solution was pipetted gradually into the drilled port, followed by an addition of 200 μL of apple sap.

After the introduction of the imidacloprid liquid or pesticide plugs in each tree, the drilled port was firmly sealed with parafilm. The trees were placed in a greenhouse and watered every two days. Four treatments were then used, which included imidacloprid cellulose plug, imidacloprid sodium carboxymethyl cellulose plug, imidacloprid liquid, and untreated control. Each treatment had three replicates, with one potted tree as a replicate.

### Extraction of Imidacloprid Residues

Ten to fifteen leaves from each tree were collected 3, 7, and 14 days after the treatment (DAT) and stored at −80° C. until the extraction process was performed. For the extraction, the leaves were ground into fine powder with a mortar and pestle by using liquid nitrogen. The pulverized leaf samples were weighed (3.5 to 5 g), then transferred into a 120 mL glass jar with 4 g of anhydrous magnesium sulfate and 1 g of sodium chloride. Dichloromethane (30 mL) was then added and the mixture mixed (e.g., using an orbital shaker) for 15 minutes. The sample was allowed to soak in the solvent overnight, then sonicated for 20 min using ultrasonic sonicator (BRANSOM 2510). Then, the solvent was filtered using Whatman 41 filter paper and 5 g of sodium sulfate into a new 120 ml glass jar. The extraction was repeated one more time. The solvent was allowed to evaporate under a fume hood and the residue was collected in 2 mL of acetonitrile. The collected sample residue was passed through a PTFE 0.45 micron syringe filters before putting into a vial. The analysis was performed using LC-MS/MS method.

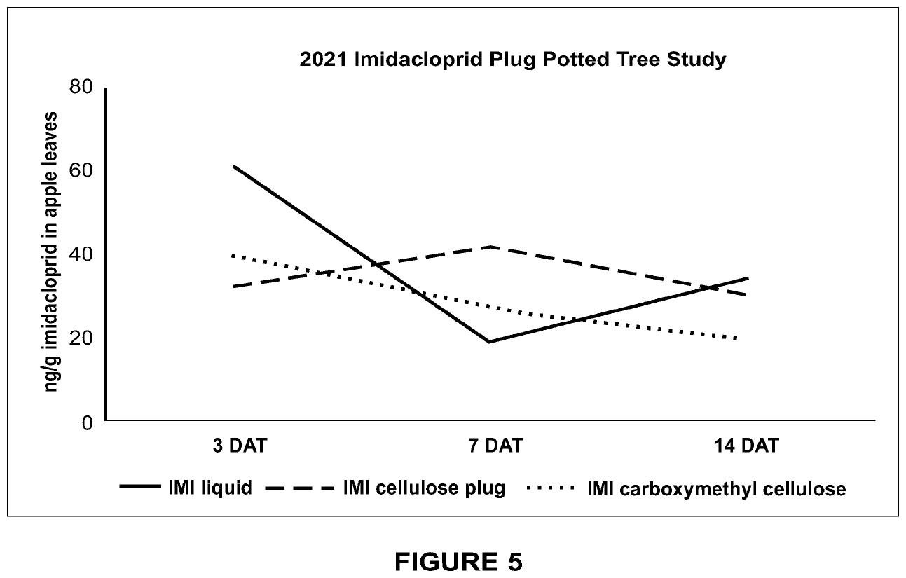

The injection of liquid imidacloprid showed the highest detections at 3 DAT, but as expected, levels declined in following dates (FIG. 5). Residue profiles for the cellulose and sodium carboxycellulose plugs demonstrated a pattern of controlled release, with more uniform detections in leaf tissues over the evaluation dates.

### Field Trial 4 Methods—Azadirachtin Plugs in Pear Trees

This example demonstrates a preparation method for and use of a pesticide plug of the disclosure containing azadirachtin and cellulose. Although no thermoplastic polymer matrix was included in the plugs for this example, a suitable thermoplastic polymer according to the disclosure (e.g., polyvinyl acetate or otherwise) could be added to the azadirachtin and cellulosic material to form a composite pesticide plug having improved mechanical strength while still providing controlled release of the azadirachtin.

The objective of this example was to compare composite pesticide plugs of the disclosure to liquid injection of the biopesticide, azadirachtin, for canopy distribution and activity on psylla in mature ‘Bartlett’ pear trees. Trees receiving foliar treatment were sprayed with an FMC 1029 AIRBLAST sprayer at the rate of 100 gallons per acre (GPA). Trees receiving trunk injection were injected with cellulose plug of the ARBORJET Tree IV using four equally spaced injection ports. Injection of the liquid formulated product was diluted into 500 mL of water and pressure injected into the tree. Liquid formulations of azadirachtin for foliar spray or trunk injection were prepared using AZASOL WP, which is a water-soluble 6% azadirachtin powder. Trees treated with plugs of the disclosure (Table 4) received weekly consecutive 10 mL doses of water into ports in the month following injection, to prime plugs simulating sap flow.

Single-tree plots were arranged in a randomized complete block (RCB) design with 4 replications. Tree spacing was 18×20 ft (about 5.4 m×6.1 m), with at least one buffer tree separating all plots. AIRBLAST applications were applied on June 11, two weeks after petal fall. Trunk injected applications and plug applications were applied on June 10. Pear psylla (PP) nymph evaluations were made on June 16, June 30, July 14, and July 27. Regular maintenance foliar applications of Agri-Mycin, Badge, Annihalate, Captan, Inspire Super, Manzate Pro, and Merivon were applied across the block.

The number of nymphs were evaluated per 50 leaf sample. Leaves were picked and brought into the laboratory for evaluation. The samples were inspected under a stereo microscope and the number of nymphs were recorded. Data are presented as the mean number of nymphs per 50 leaves. Transformed treatment means were analyzed using ANOVA and means separation by Tukey's HSD at P=0.05.

Field residue samples were be taken from treatment trees by collecting leaves 7, 28, 56, and 84 days after treatment (DAT). The leaf samples were a minimum of 40 leaves (±20 g) of tissue collected from the N, S, E, W sides of the tree, high/low and held in labeled sealed bags (e.g., ziplock bags). Leaf sample were taken to an analysis laboratory for extraction of azadirachtin residues. Briefly, ten grams (10 g) of homogenized pear leaves were placed into a 100 mL conical flask and 20.0 g of anhydrous sodium sulfate was added with mixing. Acetonitrile (30 mL) was then added and mixed (e.g. shaking). The sample was then sonicated for 20 min using ultrasonic sonicator (BRANSON 2510). The supernatant was filtered by Whatman 41 filter papers into a 250 mL round bottom flask. The extraction was repeated two more times and all the supernatants combined and concentrated at 30° C. to near dryness using a vacuum rotary evaporator. The residues were then dissolved in 1 mL of acetonitrile, filtered (e.g., PTFE 25 mm syringe filters), and placed in a gas chromatograph (GC) vial for analysis by mass spectrometry (MS) (e.g., LC/MS and LC-MS/MS). Compounds were quantified against a standard curve, and recovery data recorded as micrograms of active ingredient per gram (ppm) of plant tissue.

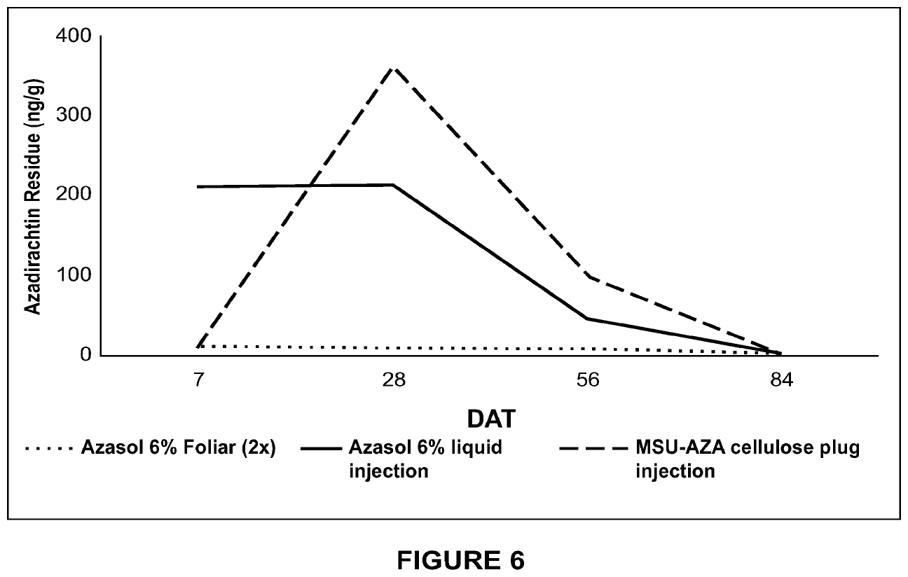

Variability in psylla pressure resulted in difficulty showing statistical support for treatment effects. However, trunk injections of the cellulose plug and liquid AZASOL product held psylla nymph populations below the threshold level of 16 nymphs/50 (0.3 per leaf) leaves at one or more dates, while numbers in the untreated check exceeded the threshold (Table 4). Residue profiles showed that injections of both the azadirachtin plug and liquid AZASOL resulted in canopy distribution throughout most of the growing season (FIG. 6). Injection of the liquid azadirachtin resulted in peak residues 7 days after injection, whereas the plug residues peaked at 28 days, showing a pattern of controlled release. ANOVA performed on log or square-root transformed data and data presented are actual counts.

TABLE 4
Results of azadirachtin plugs in pear trees

| | | No. Psylla Nympha per 50 leaves | | | |
|---|---|---|---|---|---|
| Sample | Rate² | June 16 | June 30 | July 14 | July 28 |
| UTC | — | 37 | 20.3 | 3.9 | 4.1 |
| AZASOL WP¹ | 6 oz. per acre | 19.5 | 20 | 3.2 | 5.2 |
| AZASOL WP² | 4 g per tree | 20.8 | 12.3 | 5.8 | 4.6 |
| Cellulose- | 4 plugs/tree + | 27.8 | 10 | 7.7 | 4.9 |
| azadirachtin plug³ | 100 ml water | | | | |

¹foliar application of AZASOL commercial liquid azadirachtin formulation;
²trunk injection of AZASOL commercial liquid azadirachtin formulation;
³trunk injection of cellulose-azadirachtin pesticide plug according to disclosure; and
⁴application timing was petal fall + 14 days

### Field Trial 5 Methods—Azadirachtin Plugs in Apple Trees

This example demonstrates a preparation method for and use of a pesticide plug of the disclosure containing azadirachtin and cellulose or sodium carboxymethyl cellulose. Although no thermoplastic polymer matrix was included in the plugs for this example, a suitable thermoplastic polymer according to the disclosure (e.g., polyvinyl acetate or otherwise) could be added to the azadirachtin and cellulosic material to form a composite pesticide plug having improved mechanical strength while still providing controlled release of the azadirachtin.

### Pesticide Plug Preparation

AZAPURE (240 mg) (40% technical grade, Vittal Mallya Scientific, Bengaluru, India) was added into a 25 mL-flask containing cellulose powder (1.0 g) (SIGMACELL type 101, highly purified, fibers) or sodium carboxymethyl cellulose powder (Eisen-Golden Lab 99%, food grade). Then, 1.1 and 1.0 ml of ethanol (200 Proof Pure) was transferred into the flask with the cellulose and sodium carboxymethyl cellulose, respectively, and mixed thoroughly to form a dough-like mixture. A disc of Whatman 41 filter paper (5 mm in diameter) was cut and put into the bottom of a luer lock tip 1 mL-syringe. The dough-like mixture was transferred into two 1 mL-syringes to the 8 mL mark. The syringe was placed under a fume hood for 3 to 5 days to allow the mixture to dry forming a solid plug.

### Injection and Treatment Amount of Azadirachtin

After drying, plug was pushed out of the syringe. Then 0.25 inch (about 6.4 mm) plug was cut from the 1 g batch plug. Given that the prepared 1 g batch plug would be enough to make sixteen 0.25 inch (about 6.4 mm) miniplugs, each 0.25 inch (about 6.4 mm) plug used in this study contains 3.8 mg azadirachtin. The plugs were then introduced into the trees, with one plug per tree giving a rate of 3.8 mg azadirachtin per tree. The injection was conducted on Jun. 18, 2021. Potted apple trees (150 to 175 cm in height and 2.2 to 3.4 cm of diameter at the base) grown in a greenhouse were used for this study. For the injection method, a port of 0.25 inch (about 6.4 mm) in depth was made with 0.25 inch (about 6.4 mm) wood drill bit at 8 to 17 cm from the base of the potted apple trunk. The cellulose or sodium carboxymethyl cellulose plugs were placed into the drilled hole. Azadirachtin in liquid form was also used. For that, 0.009 g of AZAPURE (40%) were put into the drilled port giving a rate of 3.8 mg azadirachtin per tree, then 300 μL of distilled water was gradually added followed by a gentle stir of the mixture in the hole. An addition of 200 μL of apple sap was performed after the introduction of the azadirachtin liquid or plug in each tree. Then, the drilled port was firmly sealed with parafilm. The trees were placed in a greenhouse yard and watered every two days. Four treatments were then used, which include azadirachtin cellulose plug, azadirachtin sodium carboxymethyl cellulose plug, azadirachtin liquid, and untreated control. Each treatment has three replicates, with one potted apple tree as a replicate.

### Bioassays with Azadirachtin

Twenty milliliters of agar (1.5%) was prepared with distilled water, poured into a plastic cup and allowed to solidify under the room temperature. Then, a Whatman 41 filter paper was put on top of the agar. Five leaves from each potted apple tree were collected 20 days after the treatment. A leaf disc of 20 mm in diameter was cut with a cork borer from each of the five leaves and placed above the filter paper in the plastic cup. Fives second- to third-instar larvae of the obliquebanded leafrollers (OBLR), Choristoneura rosaceana, were collected with a brush and placed on each leaf disc. Then, the cup was covered with its lid poked 50 times with a needle for aeration. Mortality was checked 5 days after exposure. The assay has four treatments: azadirachtin cellulose plug, MSU azadirachtin sodium carboxymethyl cellulose plug, azadirachtin liquid, and untreated control. Each treatment has three replicates with a plastic cup containing five larvae as a replicate.

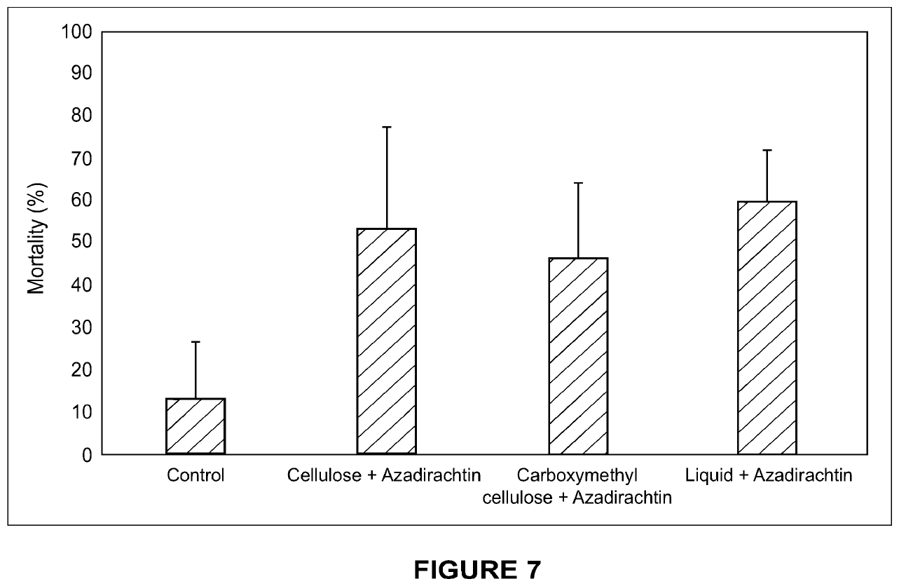

The injection of cellulose and sodium carboxycellulose plugs, and liquid azadirachtin showed high levels of lethality to OBLR larvae at 5 DAT compared to the untreated control (FIG. 7).

Because other modifications and changes varied to fit particular operating requirements and environments will be apparent to those skilled in the art, the disclosure is not considered limited to the example(s) chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

1. A composite pesticide plug for delivery of one or more plant protection materials to internal tree tissue, the composite plug comprising:
(a) a thermoplastic polymer matrix comprising a thermoplastic polymer;
(b) a cellulosic reinforcement distributed throughout the thermoplastic polymer matrix; and
(c) a plant protection material;
wherein the thermoplastic polymer is adapted to form the thermoplastic polymer matrix and the composite plug at a temperature below a degradation temperature of the plant protection material.

2. The composite pesticide plug of claim 1, wherein the thermoplastic polymer is in the form of a latex.

3. The composite pesticide plug of claim 1, wherein the thermoplastic polymer is adapted to form the thermoplastic polymer matrix and the composite plug at a temperature below 120° C.

4. The composite pesticide plug of claim 1, wherein the thermoplastic polymer is adapted to form the thermoplastic polymer matrix and the composite plug at a temperature in a range from 5° C. to 30° C.

5. The composite pesticide plug of claim 1, wherein the thermoplastic polymer comprises a non-water soluble thermoplastic polymer.

6. The composite pesticide plug of claim 1, wherein the thermoplastic polymer comprises polyvinyl acetate (PVAc).

7. The composite pesticide plug of claim 1, wherein the thermoplastic polymer matrix further comprises a biodegradable thermoplastic polymer.

8. The composite pesticide plug of claim 1, wherein the thermoplastic polymer matrix further comprises a water-soluble thermoplastic polymer.

9. The composite pesticide plug of claim 1, wherein the composite pesticide plug is free from one or both of water-soluble thermoplastic polymers and biodegradable thermoplastic polymers.

10. The composite pesticide plug of claim 1, wherein the cellulosic reinforcement is selected from the group consisting of cellulose powder, wood flour, wood fibers, wood chips, wood flakes, and combinations thereof.

11. The composite pesticide plug of claim 1, wherein the cellulosic reinforcement comprises cellulose powder.

12. The composite pesticide plug of claim 1, wherein the cellulosic material comprises a cellulose derivative selected from the group consisting of carboxymethyl cellulose (CMC) carboxymethyl hydroxyethylcellulose, hydroxyethyl cellulose (HEC), hydroxypropyl cellulose (HPC), hydroxypropyl methylcellulose (HPMC), hydroxyethyl methylcellulose (HPMC), ethyl hydroxyethylcellulose, methyl ethyl hydroxyethylcellulose, methyl cellulose (MC), ethyl cellulose (EC), ethyl methyl cellulose (EMC), diethylaminoethyl cellulose (DEAE-C), a salt thereof, and a combination thereof.

13. The composite pesticide plug of claim 12, wherein the cellulose derivative is carboxymethyl cellulose.

14. The composite pesticide plug of claim 13, wherein the carboxymethyl cellulose is sodium carboxymethyl cellulose.

15. The composite pesticide plug of claim 1, wherein the plant protection material is homogeneously distributed throughout the thermoplastic polymer matrix.

16. The composite pesticide plug of claim 1, wherein the plant protection material is selected from the group consisting of pesticides, biopesticides, plant growth regulators, fertilizers, and combinations thereof.

17. The composite pesticide plug of claim 1, wherein the plant protection material comprises a biopesticide.

18. The composite pesticide plug of claim 17, wherein the biopesticide is selected from the group consisting of azadirachtin, peptides, fermentation by-products, fungal agents, and combinations thereof.

19. The composite pesticide plug of claim 1, wherein the plant protection material comprises a pesticide.

20. The composite pesticide plug of claim 17, wherein the pesticide is selected from the group consisting of neonicotinoids, avermectins, diamides, sterol inhibitors, oxytetracycline, phosphorous acid, derivatives thereof, and combinations thereof.

21. The composite pesticide plug of claim 1, wherein the thermoplastic polymer matrix is present in an amount ranging from about 10 wt % to about 50 wt %, based on the total weight of the composite pesticide plug.

22. The composite pesticide plug of claim 1, wherein the cellulosic reinforcement is present in an amount ranging from about 30 wt % to about 60 wt %, based on the total weight of the composite pesticide plug.

23. The composite pesticide plug of claim 1, wherein a ratio of polyvinyl acetate to cellulosic reinforcement in the composite pesticide plug is in a range of about 1:4 to about 1:1.

24. The composite pesticide plug of claim 1, wherein the ratio of polyvinyl acetate to cellulosic reinforcement in the composite pesticide plug is about 1:3 to 2:3.

25. The composite pesticide plug of claim 1, wherein the plant protection material is present in an amount ranging from about 10 wt % to about 30 wt %, based on the total weight of the composite pesticide plug.

26. The composite pesticide plug of claim 1, wherein the plug has an elongate geometry.

27. A pesticide plug for delivery of one or more plant protection materials to internal tree tissue, the pesticide plug comprising:
(a) a cellulosic material; and
(b) a plant protection material.

28.-40. (canceled)

41. A method for delivering a plant protection material to a tree, the method comprising:
inserting the plug of claim 1 into an interior trunk region of a live tree.

42. The method of claim 41, comprising inserting the composite pesticide plug at a height ranging from about 0.1 m to about 1 m above ground.

43. The method of claim 41, comprising inserting a plurality of the composite pesticide plugs distributed circumferentially around the tree trunk.

44. The method of claim 41, wherein the tree is a fruit tree selected from the group consisting of apple trees, cherry trees, grapefruit trees, lemon trees, nectarine trees, orange trees, peach trees, pear trees, plum trees, and pomegranate trees.

45. A method of preparing the composite pesticide plug of claim 1, the method comprising:
admixing the thermoplastic polymer, the cellulosic reinforcement, and the plant protection material to provide the composite pesticide plug, wherein the admixing is performed at a temperature of about 15° C. to about 30° C.

46. The method of claim 45, wherein:
the admixing further comprises adding at least one liquid to the thermoplastic polymer, the cellulosic reinforcement, and the plant protection material, thereby forming a moldable mixture comprising the liquid, the thermoplastic polymer, the cellulosic reinforcement, and the plant protection material; and
the method further comprises drying the moldable mixture to remove at least some of the liquid, thereby forming the composite pesticide plug.

47. The method of claim 46, wherein the method is free of a heat extrusion process.

48. The method of claim 46, wherein the method is free of a melt processing step.

49. A method of preparing the pesticide plug of claim 27, the method comprising:
admixing the cellulosic material and the plant protection material to provide the pesticide plug,
wherein the admixing is performed at a temperature of about 15° C. to about 30° C.

50.-52. (canceled)
